(19) United States
(12) Patent Application Publication
(10) Pub. No.: US 2013/0212505 A1
(43) Pub. Date: Aug. 15, 2013

(54) Method and Apparatus for Performing a Geometric Transformation on Objects in an Object-Oriented Environment using a Multiple-Transaction Technique

(71) Applicant: Intergraph Corporation, (US)

(72) Inventor: Steven D. Herold, Madison, AL (US)

(73) Assignee: INTERGRAPH CORPORATION, Madison, AL (US)

(21) Appl. No.: 13/736,357

(22) Filed: Jan. 8, 2013

Related U.S. Application Data
(60) Provisional application No. 61/596,797, filed on Feb. 9, 2012.

(51) Int. Cl. G06F 3/0484

(52) U.S. Cl. CPC G06F 3/04842
USPC 715/765

(57) ABSTRACT

A large number of objects, such as objects representing beams and columns in an object-oriented enterprise engineering system, may be geometrically transformed in a model database by dividing the objects according to criteria into a number of ordered partitions and transforming the objects in each partition as an atomic operation. Objects that are to be transformed are organized into the ordered partitions, and the partitions are transformed in sequential order, such that all predecessors of a given object are transformed before, or in the same operation as, the given object. If a large transformation operation abnormally terminates before all the small transformation operations have been completed, the model database is, nevertheless, left in a consistent state. The transformation operation may be resumed from the point of interruption. Furthermore, the number of objects that may be transformed is not constrained by the amount of memory available in the system.

### CROSS REFERENCE TO RELATED APPLICATIONS

This application claims the benefit of U.S. Provisional Patent Application No. 61/596,797, filed Feb. 9, 2012, titled “Method and Apparatus for Performing a Geometric Transformation on Objects in an Object-Oriented Environment using a Multiple-Transaction Technique,” the entire contents of which are hereby incorporated by reference herein, for all purposes.

### TECHNICAL FIELD

The present invention relates to computer-aided design and computer-aided manufacturing (CAD/CAM) software systems and, more particularly, to methods and apparatus for performing geometric transformations on large numbers of objects and relationships in databases used by such systems.

### BACKGROUND ART

Enterprise engineering systems, sometimes also referred to as spatial information management (SIM) systems, are computer-aided design (CAD) systems that facilitate two-dimensional (2D) and three-dimensional (3D) modeling and visualization. These systems are used in the design, construction, operation and modification of industrial plants, such as oil refineries and power generating stations, as well as other large, complex structures, such as high-rise buildings, ships, and mining and other materials handling facilities. With their graphical user interfaces (GUIs), enterprise engineering systems enable designers to lay out structural, piping, electrical, heating, ventilating and air conditioning (HVAC) and other complex systems and to visualize all or selected portions of a project at various stages of construction or operation.

Most modern enterprise engineering systems utilize object-oriented paradigms, in which software constructs called “objects” represent real-world items, such as beams, walls, floors, pipe runs, valves, conduits, switches, fans, ducts and the like. Some objects represent items, such as coordinate grid systems, that are mere conveniences to a designer and do not represent physical items.

Objects are typically implemented in software as data structures (ordered groups of data elements) that store information identifying the types of items represented, as well as information (such as length, width, color, capacity, etc., as appropriate for each item) about the specific item represented by each object. Objects typically also include “methods,” which are routines that manipulate the data elements of the object and/or return information about the objects to callers. Objects that represent items within a user's problem domain and that are visible to the user and that can be manipulated by the user via a SIM system user interface (UI) are sometimes referred to as “design objects” to distinguish them from subordinate objects (described below) or objects that may not be directly visible to the user but that are, nonetheless, necessary for the model.

Many design objects are made up of other (“subordinate”) objects. For example, a beam may be composed of a single member system and many subordinate objects including: frame connections (representing how the beam is connected to other members at each end), parts (representing the final physical objects), ports (representing connection points along the beam) and other objects. Openings in a beam are represented by respective additional objects. If an end of a beam is trimmed, the trim operation is also represented by an object. In some cases, when a user adds an object to a model, the SIM system automatically adds appropriate subordinate objects to the model. Collectively, a design object and its related subordinate objects are referred to as a “design object group.”

Most objects are linked to other objects by means of relationships. Different types of relationships are used in different contexts. For example, one type of relationship is used to arrange objects into a logical hierarchy of “systems.” A different type of relationship is used when a pipe is connected to a nozzle on a piece of equipment. A third type of relationship is used to connect a beam to a column.

Relationships between objects are ordered concepts. A relationship may indicate a logical order in which the corresponding objects were added to a model, which may be different than the order the real-world items will be constructed. For example, when modeling a power plant building, a designer typically establishes a grid coordinate system. The designer then adds columns and places the columns at desired coordinates within the grid system. Later, the designer adds footings under the columns. However, when the power plant is actually built, the footings are constructed before the columns can be put in place on top of the footings.

Another type of relationship between objects is a “functional dependency.” A functional dependency may exist between related objects (an “independent” object and one or more “dependent” objects). When an independent object is changed, all dependent objects are automatically changed as well. In the previous column and footing example, the column is the independent object and the footing is dependent on it. If the column is moved or the weight it must bear changes, the enterprise engineering systems automatically moves the footing or automatically changes its size or weight-bearing capacity as required. In addition, characteristics of any other objects that are dependents of the column are automatically recalculated by the enterprise engineering system. Updating an object, i.e., recalculating one or more of the object's parameters, is sometimes referred to as “recomputing” the object.

As noted, during the modeling phase, a column object is typically added to a model before a corresponding footing object is added to the model. However, when the physical structure (ex., a power plant) is constructed, the footing must be built before the column can be attached to the top of the footing. Thus, the order in which objects are added to a model is not necessarily the same as the order in which corresponding real-world items are constructed or put in place. Similarly, functional dependency relationships do not necessarily indicate the order in which real-world items are constructed or put in place.

Many modern enterprise engineering systems utilize relational databases (RDBs) or other database management systems (DBMSs) to store persistent data structures that represent objects and relationships. For example, RDB records or table rows may be used to store object and relationship data structures.

One particularly useful feature of enterprise engineering systems is the ability to geometrically transform an object or a user-selected group of objects. Examples of geometric transformations include moving an object and rotating an object.

In order to maintain the validity and consistency of objects and relationships in a model database, every operation on that database is performed within a database transaction. A transaction has two main purposes: 1) to provide a reliable unit of work that allows for correct recovery from system failures; and 2) to provide isolation between programs accessing a database concurrently. A transaction provides an “all or nothing” proposition. Either all modifications to the database are completed successfully or none are completed.

Thus, to ensure validity and consistency of the model, an enterprise engineering system typically performs a geometric transformation in a single transaction. The transaction includes three steps. In the first step, the transaction is started and all data structures representing the objects and relationships to be transformed are brought from the database into memory. In the second step, the objects are transformed in memory and all dependent objects are recomputed. Then, in the third step, the (now modified) data structures representing objects and relationships are written back to the database and the transaction is committed.

Many industrial plant models involve very large numbers of objects and relationships, which can pose problems for enterprise engineering systems. A system's (virtual) memory must be large enough to simultaneously store all the data structures representing the objects that are to be geometrically transformed and their relationships. Selecting a large portion of a model for a geometric transformation, such as moving a distiller within a petrochemical plant, may cause the memory capacity of the system to be exceeded.

### SUMMARY OF EMBODIMENTS

An embodiment of the present invention provides a computer-implemented method for geometrically transforming a plurality of objects represented within an object-oriented enterprise engineering system. At least one of the plurality of objects is a predecessor of another of the plurality of objects. The method involves a processor performing several operations, including accepting input from a user selecting the plurality of objects to be geometrically transformed, as well as accepting an indication of a type of geometric transformation that is to be performed on the selected objects. For each selected object, among the plurality of objects, any predecessor objects of the selected object are automatically identified. A value of at least one parameter of the selected object is functionally dependent on at least one parameter of the any predecessor objects. The selected objects are automatically divided into a plurality of ordered partitions of objects. For any given object, each of the object's predecessor objects is in the same partition as the given object or in a preceding partition.

The objects are geometrically transformed, according to the indication of the type of geometric transformation, per partition of objects, in partition order. While geometrically transforming the objects in a given partition, any successor object of each object in the partition is temporarily made read-only. Any predecessor object of each object in the partition is temporarily made read-only. For each object made temporarily read-only, a corresponding to-do item may be generated. If any of the temporarily made read-only objects is subsequently transformed, the corresponding to-do item may be deleted.

While geometrically transforming the objects in a given partition, any subordinate objects of the objects in the partition may be identified. The identified subordinate objects may be added to the partition, and the added subordinate objects may be geometrically transformed, according to the indication of the type of geometric transformation.

At least two of the partitions may be processed in partition order. The processing includes saving information about the partition and geometrically transforming the objects in the partition, according to the indication of the type of geometric transformation, before processing a subsequent partition. The saved information may include information sufficient to restart geometrically transforming the objects in the partition.

Automatically dividing the selected objects into a plurality of ordered partitions of objects may include generating a predecessor graph that relates each selected object to all the selected object's predecessor objects.

The method may include identifying at least one external object that is related to any of the selected objects and disconnecting the relationship between identified external object and the selected object.

Another embodiment of the present invention provides a system for geometrically transforming a plurality of objects represented within an object-oriented enterprise engineering system. At least one of the plurality of objects is a predecessor of another of the plurality of objects. The system includes a user interface configured to accept a first input from a user selecting a plurality of objects to be geometrically transformed and for accepting a second input from the user indicating a type of geometric transformation that is to be performed on the selected objects. An identification module is coupled to the user interface and is configured, for each selected object, to automatically identify any predecessor objects corresponding to the selected object. A value of at least one parameter of the selected object is functionally dependent on at least one parameter of the any predecessor objects. A partitioning module is coupled to the identification module and is configured to automatically divide the selected objects into a plurality of ordered partitions of objects. For any given object, each of the object's predecessor objects is in the same partition as the given object or in a preceding partition.

A transformation module may be coupled to the partitioning module and configured to geometrically transform the objects, according to the indicated type of geometric transformation, per partition of objects, in partition order.

A freezing module may be coupled to the transformation module and configured to, on a per-partition basis, temporarily make any successor object of each object in the partition read-only and temporarily make any predecessor object of each object in the partition read-only. The freezing module may be configured to generate a corresponding to-do item for each object made temporarily read-only.

A clean-up module may be coupled to the transformation module and configured to delete the corresponding to-do item, if any of the temporarily made read-only objects is subsequently transformed.

A propagation module may be coupled to the identification module and configured, for each partition, to identify any subordinate objects of the objects in the partition and add the identified subordinate objects to the partition. The transformation module is configured to geometrically transform the added subordinate objects, according to the indicated type of geometric transformation.

A process control module may be coupled to the transformation module and configured to process at least two of the partitions in partition order. The process control module may be configured, for each partition, to save information about the partition. The saved information includes information sufficient to restart geometric transformation the objects in the partition. The process control module may be configured to cause the transformation module to geometrically transform the objects in the partition, according to the indicated type of geometric transformation, before processing a subsequent partition.

The partitioning module may be configured to generate a predecessor graph that relates each selected object to all the selected object's predecessor objects.

A pruning module may be configured to identify at least one external object that is related to any of the selected objects and disconnect the relationship between the identified external object and the selected object.

Yet another embodiment of the present invention provides a computer program product for use on a computer system. The computer program product may be used for copying a plurality of predecessor and successor objects represented within an object-oriented enterprise engineering system. Each successor object has a predecessor relationship with a predecessor object. The computer program product includes a non-transitory computer-readable medium on which are stored computer instructions. When executed by a processor, the instructions cause the processor to accept input from a user. The input selects the plurality of objects to be geometrically transformed, and the input provides an indication of a type of geometric transformation that is to be performed on the selected objects. For each selected object, the instructions cause the processor to automatically identify, among the plurality of objects, any predecessor objects of the selected object. A value of at least one parameter of the selected object is functionally dependent on at least one parameter of the any predecessor objects. The instructions also cause the processor to automatically divide the selected objects into a plurality of ordered partitions of objects. For any given object, each of the object's predecessor objects is in the same partition as the given object or a preceding partition.

The instructions may cause the processor to geometrically transform the objects according to the indication of the type of geometric transformation, per partition of objects, in partition order.

The instructions may cause the processor to temporarily make any successor object of each object in the partition read-only and temporarily make any predecessor object of each object in the partition read-only.

For each object made temporarily read-only, the instructions may cause the processor to generate a corresponding to-do item. If any of the temporarily made read-only objects is subsequently transformed, the instructions may cause the processor to delete the corresponding to-do item.

While geometrically transforming the objects in a given partition, the instructions may cause the processor to identify any subordinate objects of the objects in the partition and add the identified subordinate objects to the partition. The instructions may cause the processor to geometrically transform the added subordinate objects, according to the indication of the type of geometric transformation.

### BRIEF DESCRIPTION OF THE DRAWINGS

The invention will be more fully understood by referring to the following Detailed Description of Specific Embodiments in conjunction with the Drawings, of which:

FIG. 1 is a schematic representation of a hypothetical set of objects and hypothetical relationships among the objects.

FIG. 2 is a schematic representation of design objects of FIG. 1, sorted and partitioned in preparation for geometric transformation, according to an embodiment of the present invention;

FIG. 3 is a schematic block diagram of a modular enterprise engineering system, according to an embodiment of the present invention.

FIG. 4 is a flowchart illustrating overall operation of an embodiment of the present invention.

FIGS. 5-13 illustrate aspects of an exemplary user interface to an embodiment of the present invention.

FIG. 14 is a high-level flowchart illustrating sub-operations of a transformation operation of FIG. 4.

FIG. 15 is a flowchart illustrating operations to divide the list of object identifiers (OIDs) into ordered partitions, expanding on an operation of FIG. 4.

FIG. 16 is a schematic diagram of two design objects and corresponding respective subordinate objects, according to an embodiment of the present invention.

FIG. 17 contains an exemplary XML file fragment for providing class information to enable traversal of relationship paths, such as in the objects of FIG. 16, according to an embodiment of the present invention.

FIG. 18 is a more complete example of an XML class descriptor file, according to an embodiment of the present invention.

FIG. 19 illustrates an exemplary predecessor graph, according to an embodiment of the present invention.

FIG. 20 schematically illustrates examples of loops in relationships between or among objects.

FIG. 21 is a flowchart summarizing operations ordering partitions and processing the partitions in sequence, according to an embodiment of the present invention.

FIG. 22 is a flowchart illustrating processing objects in a selected partition, expanding on such an operation of FIG. 21, according to an embodiment of the present invention.

FIG. 23 is a schematic diagram of a transform graph data structure, according to an embodiment of the present invention.

FIG. 24 is a schematic diagram of a value entry array of the transform graph data structure of FIG. 23, according to an embodiment of the present invention.

FIG. 25 is a schematic diagram of a value entry of the array of FIG. 24, according to an embodiment of the present invention.

FIG. 26 is a schematic diagram of a relationship entry of the transform graph data structure of FIG. 23, according to an embodiment of the present invention.

FIG. 27 is a schematic diagram illustrating several hypothetical objects and relationships therebetween, according to an embodiment of the present invention.

FIG. 28 is a schematic representation of a predecessor graph, corresponding to the objects and relationships of FIG. 27.

FIG. 29 is a schematic diagram illustrating the objects of FIGS. 27 and 28, after the objects have been divided into partitions, according to an embodiment of the present invention.

FIGS. 30-33 illustrate four hypothetical transactions to exemplify operation of an embodiment of the present invention.

FIGS. 34A-B contain a flowchart that schematically illustrates a computerized method for geometrically transforming a plurality of objects represented within an object-oriented enterprise engineering system, according to an embodiment of the present invention.

FIG. 35 contains a schematic block diagram of a system for geometrically transforming a plurality of objects represented within an object-oriented enterprise engineering system, according to an embodiment of the present invention

### DETAILED DESCRIPTION OF SPECIFIC EMBODIMENTS

According to the present invention, methods and apparatus are disclosed for geometrically transforming a large number of objects, while maintaining integrity of a model database, but without the memory constraints of the prior art. A large geometric transformation operation is divided into a number of smaller atomic operations (transactions) that are performed sequentially. Each small transaction geometrically transforms a selected subset of the objects. Thus, if a large geometric transformation operation is interrupted before all the small geometric transformation transactions have been completed, the model database is, nevertheless, left in a consistent state, and the overall geometric transformation operation may be resumed from the point of interruption.

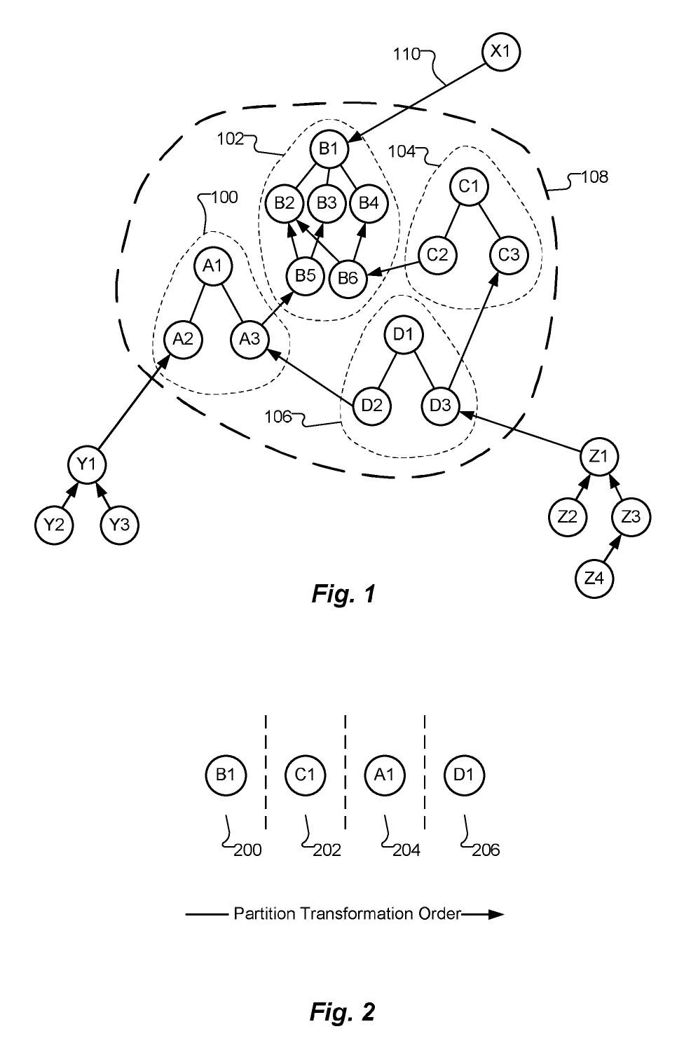

I recognized that the order in which objects are geometrically transformed is important. I begin my description with FIG. 1, which schematically represents a number of hypothetical objects A1, A2, A3, B1, . . . Z4 and relationships (represented by solid lines) between pairs of the objects A1-Z4. FIG. 1 shows a relatively small number of objects for simplicity of explanation. Objects A1, B1, C1 and D1 represent design objects. As noted, a design object may be made up of zero or more subordinate objects. For example, objects C2 and C3 are subordinate objects of the design object C1. Each collection of subordinate objects forms a hierarchy descending from its respective design object. Each design object and its respective subordinate objects are enclosed by a respective light dashed line 100, 102, 104 or 106.

Some pairs of the objects A1-Z4 are in functionally dependent relationships, as indicated by arrows. For example, object B6 depends from object B4. This means at least one parameter of object B6 depends on at least one parameter of object B4. Thus, if a parameter of object B4 changes, one or more parameters of object B6 should be recomputed based on the changed parameter(s) of object B4. Thus, at least with respect to the relationship between objects B4 and B6, object B6 is referred to as being “dependent,” and object B4 is referred to as being “independent.” Note that some functional relationships cross design object boundaries. For example, object A3, which is part of design object A1, is functionally dependent on object B5, which is part of a different design object B1.

The fact that subordinate object A3 is dependent on object B5 implies that design object B1 is a “predecessor” (as that term is used herein) of design object A1, even though there is no explicit relationship between design objects A1 and B1. As used herein, a predecessor object is a design object, upon which another design object depends. That is, the dependent design object or one or more of its subordinate objects depends on the predecessor design object or one or more of its subordinate objects. Thus, if a parameter of the predecessor design object or one or more of its subordinate objects changes, one or more parameters of the dependent design object or one or more of its subordinate objects should be recomputed. The implied relationship between design objects A1 and B1 is induced by the actual relationship between the subordinate objects A3 and B5. Design objects can, however, have explicit relationships (not shown) with other design objects.

It should be noted that a predecessor relationship is completely different than a parent-child (a.k.a. class-subclass or generalized hierarchy or class-instance) relationship from the object-oriented programming paradigm. A subclass inherits attributes, such as variables and methods, from its superclass. Similarly, an instance inherits attributes from its class definition. Typically, a subclass adds functionality, such as additional variables or methods, although in some cases the subclass overrides variables and/or methods of its superclass. For example, a class may be defined for “vehicle,” which includes variables for “weight” and “number_of_wheels” and might include a method for “accelerate,” which takes as an input a distance a gas pedal has been depressed. Instances of the class may be objects that represent various cars and trucks. A subclass may be defined for “crane,” which might add variables for “max_lift_weight” and “max_lift_height” and possibly methods that can be invoked to perform functions, such as raising or lowering a load.

Predecessor relationships are unrelated to class-subclass relationships. Predecessor relationships are not known from the object-oriented paradigm; they were conceived by the inventor of the present Application for purposes described in the Application. A predecessor relationship does not imply inheritance. Functional dependencies are not inheritances. A predecessor object does not automatically inherit properties (variables) or methods from its dependent object, or vise-versa. Instead, if a parameter of a predecessor design object or one or more of its subordinate objects changes, one or more parameters of the dependent design object or one or more of its subordinate objects should be recomputed.

Objects in predecessor relationships are not necessarily in class-subclass relationships. Typically, predecessor objects are in neither subclasses nor superclasses of their successor objects. For example, pumps and pipe runs are typically in entirely different classes, as are beams and columns. Furthermore, a subclass/superclass relationship does not imply a functional relationship. That is, if an object of one class is altered (such as by being moved to a new location), objects in its subclasses and superclasses do not need to be recalculated.

Assume the design objects A1, B1, C1 and D1 are selected for transformation. The objects that are to be transformed are enclosed by a heavy dashed line 108. Note that some objects, such as objects X1, Y1 and Z1, are related to objects that are to be transformed, but that objects X1-Z4 are not selected for transformation.

If the objects within dashed line 108 were geometrically transformed in an arbitrary order, and the geometric transformation operation were abnormally terminated, the database might be left in an inconsistent state, because some dependent objects might be geometrically transformed, but the objects from which they depend might not be transformed, by the time the transformation operation abnormally terminates.

In accordance with my methods and apparatus, objects are divided into ordered sets (also referred to as “partitions”) of selected objects according to certain rules, and the partitions are geometrically transformed in sequential order. That is, all the objects of a partition are transformed before any of the objects in any subsequent partition are transformed. The objects are assigned to partitions, such that dependent objects are transformed no earlier than the objects from which they depend are transformed.

FIG. 2 shows an exemplary division of the design objects A1-D3 into ordered partitions 200, 202, 204 and 206, according to my rules. For example, design object D1 and its subordinate objects (i.e., partition 206) are not transformed until the objects represented by partition 202 (design object C1 and its subordinate objects) and partition 204 (design object A1 and its subordinate objects) have been transformed, because design object D1 (or at least one of its subordinate objects) depends on an object in partition 202 and an object in partition 204. A “successor partition” is a partition that contains an object that depends on an object in another partition. For example, partition 206 is successor partition to each of partitions 202 and 204. A “predecessor partition” is a partition that contains an object, upon which another object in another partition depends. For example, partition 204 is a predecessor partition to partition 206.

Each partition 200-206 is transformed in a corresponding distinct transaction. That is, for each partition 200-206, a transaction is performed, and all the design objects within the partition and their respective subordinate objects are transformed during the transaction. The example shown in FIG. 2 includes only one design object per partition 200-206, which I prefer; however, a partition may include more than one design object. Transforming the objects in a partition is also referred to as “transforming the partition.” As noted, the partitions are transformed in sequential order. For example, partition 202 is transformed after partition 200.

As each partition is transformed, all objects in successor partitions (and their respective subordinate objects, if any) are placed into a temporary “frozen” state. For example, as partition 202 is transformed, all objects in partition 206 (and their subordinate objects) are frozen. A frozen object is considered to be temporarily read-only. That is, if the frozen object is dependent on another object, the frozen object is not immediately recomputed in response to its independent object being modified. Instead of immediately recomputing the frozen object, the system generates a “to-do” record for each frozen object, which effectively defers transforming the frozen object until its respective partition is transformed. In addition, some objects may be frozen to support disconnecting relationships to other objects. For example, objects that are not being transformed, but that are related to objects that are to be transformed, are referred to as “external objects.” In the example shown in FIG. 1, objects X1, Y1 and Z1 are external objects, and objects (such as objects A2, B1 and D3) that are related to the external objects are frozen to facilitate disconnecting the relationships.

Each partition of objects is geometrically transformed in an atomic operation (transaction), which leaves the database consistent, even if the large geometric transformation operation abnormally terminates. If a large geometric transformation operation is abnormally terminated, the transformation operation may be resumed at the point where it terminated. For example, if a hardware failure caused the abnormal termination, the transformation operation may be resumed after the failure has been rectified. In another example, if some of the objects that are to be transformed are marked as “read-only” in the database, the transformation operation may be restarted after these objects' protections have been modified to permit altering these objects' parameters, i.e., making these objects “read-write.” Furthermore, a very large number of objects can be geometrically transformed, without regard to the amount of available memory, by dividing the objects into sufficiently small partitions, because only a relatively small number of objects need to be loaded into memory at a time. The objects that need to be loaded into memory include: objects from the current partition, objects from any predecessor partition(s) and objects from any successor partition(s). Once the geometrically transformed objects are committed to the database, the memory may be reused.

To support restarting a large geometric transformation, information about the transformation is stored in the database, essentially as a “transformation operation object.” The status of each partition's transformation transaction is also stored in the transformation operation object. Thus, if a geometric transformation operation needs to be restarted, information about which partitions have already been transformed, as well as information about which partitions have not yet been transformed, is available, so the transformation operation can resume where it left off.

### External Relationships

As noted, an “external relationship” is one that crosses a boundary between objects that are to be transformed and objects that will not be transformed. For example, in FIG. 1, any relationship that crosses the heavy dashed line 108 is an external relationship, regardless of any functional dependency between the related objects. In FIG. 1, object X1 is dependent upon object B1. However, object X1 is not selected for transformation. Thus, the relationship 110 between objects B1 and X1 is an external relationship. If the dependent object (in this example, X1) can exist without a relationship to its independent object (in this example, B1), the external relationship is broken (i.e., the objects are disconnected from each other), and, in one embodiment, the dependent object (X1) becomes independent. On the other hand, in this embodiment, if the dependent object (X1) cannot exist without a relationship to its independent object (B1), the dependent object (X1) is deleted.

Which objects can exist without relationships is domain specific. That is, a designer of the enterprise engineering system determines which relationships are external relationships. For example, systems of pipes are made out of PipeRuns. A PipeRun is a design object. Therefore, a PipeRun is the smallest unit of piping that can be transformed with the multi-transaction method. A PipeRun can be made up of multiple logical “features,” such as straight features, turn features, along-leg features, branch features, etc. Each feature can correspond to a physical part, such as a straight pipe, an elbow, a valve or a tee component. The physical parts that are adjacent one another are related to each other by means of connection objects. Connection items, such as welds or gaskets, can be associated with each connection. Thus, a single PipeRun may have many features, parts, connections and connection items. The relationships between the PipeRun and these objects may be internal relationships. For example, if a PipeRun is transformed (such as moved), all these objects may be transformed (moved) along with the PipeRun.

On the other hand, a first PipeRun can also be connected to a second PipeRun or to a nozzle on a piece of equipment. The relationships between members of the first PipeRun and members of the second PipeRun or Equipment may be external relationships. In this case, if the first PipeRun is transformed (such as moved), the external objects need not be transformed. For example, if the first PipeRun is moved, the relationship to the second PipeRun or the Equipment is identified as an external relationship. Because the second PipeRun (and the Equipment) can exist as an independent object, the relationship can be broken.

### Architectural Overview

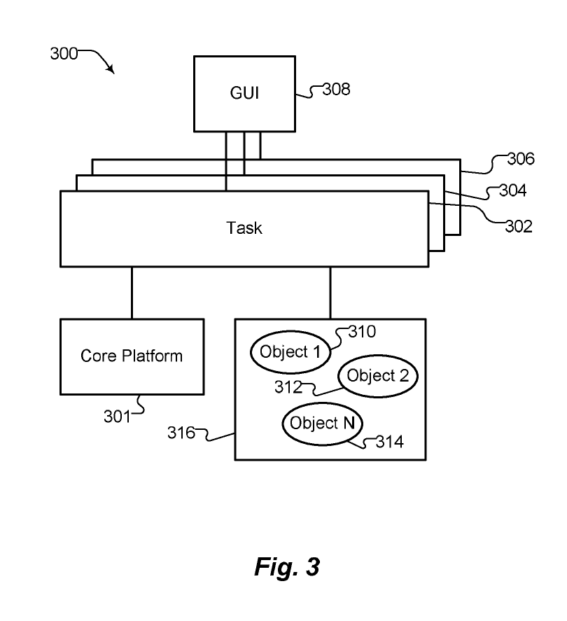

The methods and apparatus described herein for geometrically transforming objects may be implemented in a variety of contexts, such as an enterprise engineering system. A modular exemplary enterprise engineering system 300 is schematically illustrated in FIG. 3. A core software platform 301 provides common services (i.e., services to one or more tasks), including geometric transformation, used in relation to a variety of design objects. The core platform 301 may provide other common services, such as copying groups of objects, as described in commonly-assigned U.S. patent application Ser. No. 12/476,399 (Pat. Publ. No. US 2009/0300083), the entire contents of which are hereby incorporated by reference for all purposes. Other examples of common services may include transaction management, graphic display, edit and undo operations, revision management and DBMS interface. All design objects share a common three-dimensional workspace provided by the core platform 301.

One or more software tasks, exemplified by tasks 302, 304 and 306, make calls to the core platform 301 and provide problem domain-specific services to users via a graphical user interface (GUI) 308. Exemplary software tasks include tasks that implement structural systems, electrical systems, equipment systems and piping systems. Each task 302-306 includes its own set of menus, its own set of objects and relationships and its own set of functional dependencies. Of course, some types of relationships can cross the boundary from objects of one task 302-306 to objects of another task 302-306. Each task 302-306 implements objects, exemplified by objects 310, 312 and 314, that are appropriate for the task's needs. The objects 310-314 may be stored in a relational database (RDB) 316 or another suitable database. The software architecture shown in FIG. 3 facilitates adding new tasks to an enterprise engineering system without impacting existing tasks.

### High-Level Operations Overview

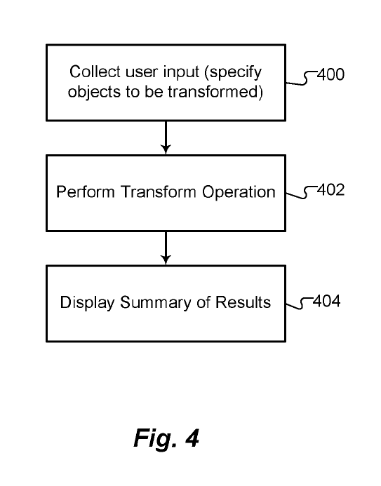

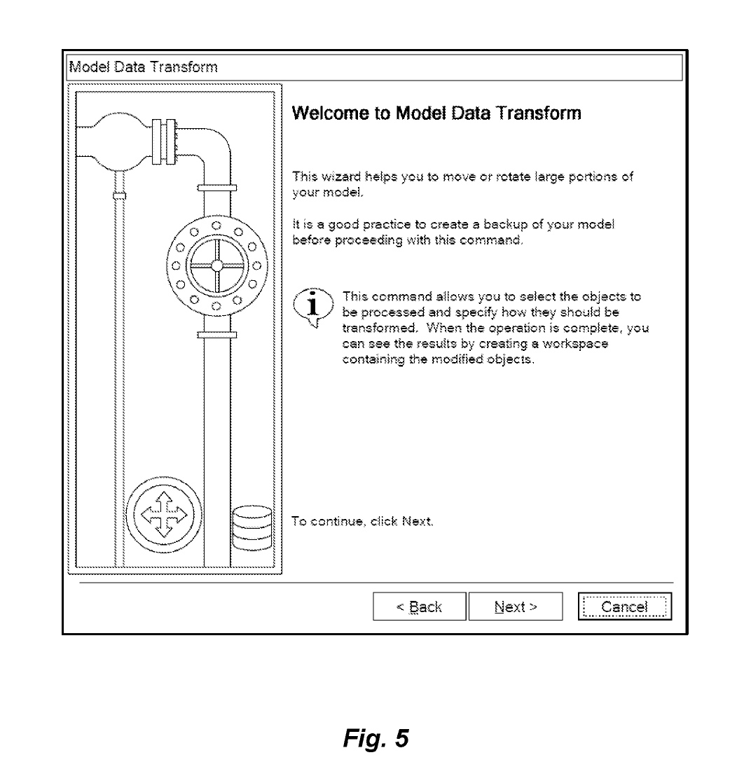

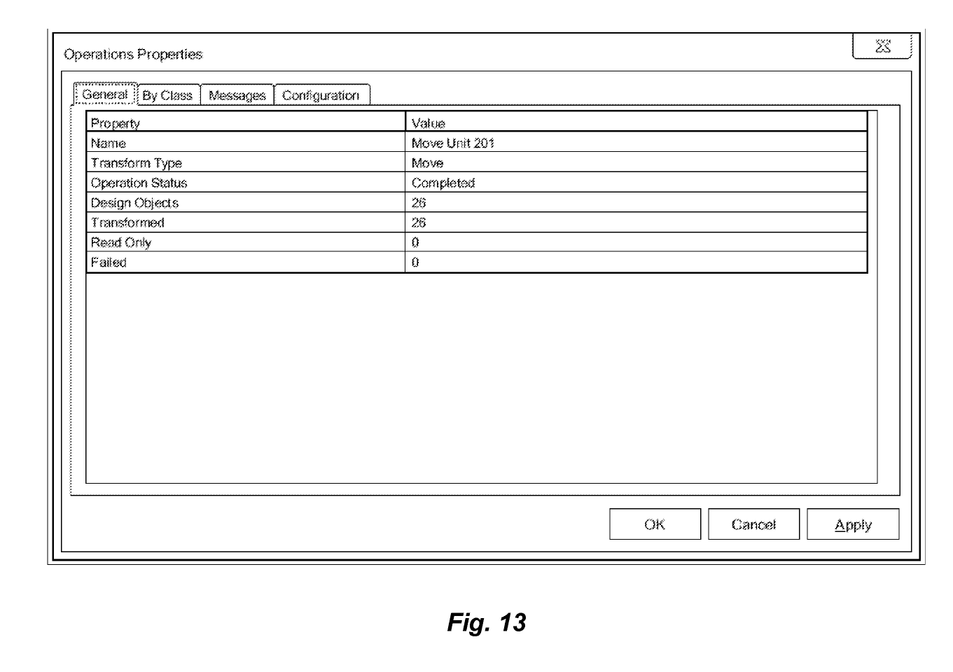

FIG. 4 contains a high-level flowchart illustrating major operations performed by the core platform 301 (FIG. 3) to geometrically transform one or more objects. Each of these operations is summarized here and described in more detail below. At 400, user input is collected to specify the objects to be transformed, as well as the type(s) of transform(s) (such as move, rotate and/or mirror) to be performed on the objects and parameters of the transformation (such as distance, angle of rotation, center of rotation and/or axis for mirroring, as the case may be). The user interface 308 (FIG. 3) may allow the user to select objects from a menu of choices or to enter or select filter criteria, which the system then uses to automatically select objects that satisfy the criteria. Alternatively, the user interface may provide a graphical selection tool, such as a selection cursor or a “rubber band” selection rectangle (or other shape), or any other suitable selection metaphor. Aspects of an exemplary “wizard” style user interface for prompting the user and for accepting the user's inputs are described below, with reference to FIGS. 5-12. At 402, the transformation operation is performed, as described in detail below. At 404, a displaying of information about a transformation operation is presented to the user. An exemplary summary display is shown in FIG. 13.

### User Interface to Collect User Input Specifying Objects to be Transformed

As noted with respect to the flowchart of FIG. 4, user input is collected (400) to specify the objects to be transformed. Aspects of an exemplary “wizard” style user interface for prompting the user and for accepting the user's inputs and displaying information about a transformation operation are described below, with reference to FIGS. 5-13. FIG. 5 illustrates an exemplary dialog box that introduces the model data transform system wizard.

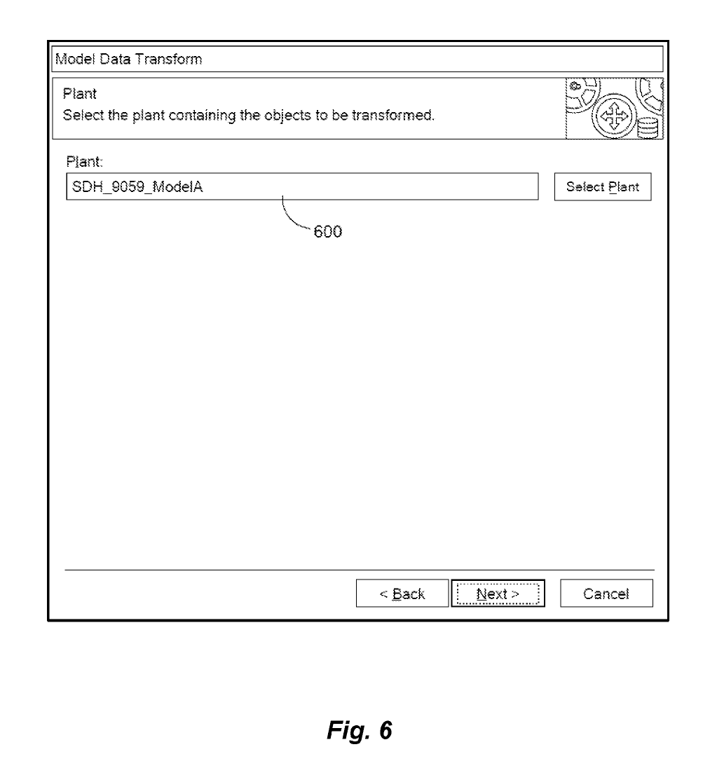

Using a dialog box shown in FIG. 6, the system may accept user inputs that select a portion of an existing model that is to be copied. As used in the exemplary dialog box, the term “plant” refers to a database. Thus, in the example shown in FIG. 6, the user has selected a source “plant” 600 (i.e., a database) named “SDH_{—}9059_ModelA.” Each database stores information about a model in a hierarchy of “systems.” Exemplary systems include structural systems (which may include objects such as footings, beams and columns), electrical systems (which may include conduit, wire runs, switches and the like), equipment systems (which may include pumps and tanks) and piping systems (which many include pipes, elbows, T-connections, valves and the like). The granularity of the hierarchy depends on the particular enterprise engineering system being used and user requirements.

As noted, an enterprise engineering system may include design objects that are exposed to a user through a user interface, as well as other subordinate objects that are not exposed. For example, the system may expose design structural objects, such as footings, columns and beams. The user may manipulate these design objects through the user interface. For example, the user may move a column or specify its dimensions. The system may use the unexposed subordinate objects to store information about the exposed objects. For example, an I-beam design object may be related to subordinate objects representing the primary axis of the I-bean, its cross section, logical connection ports, etc.

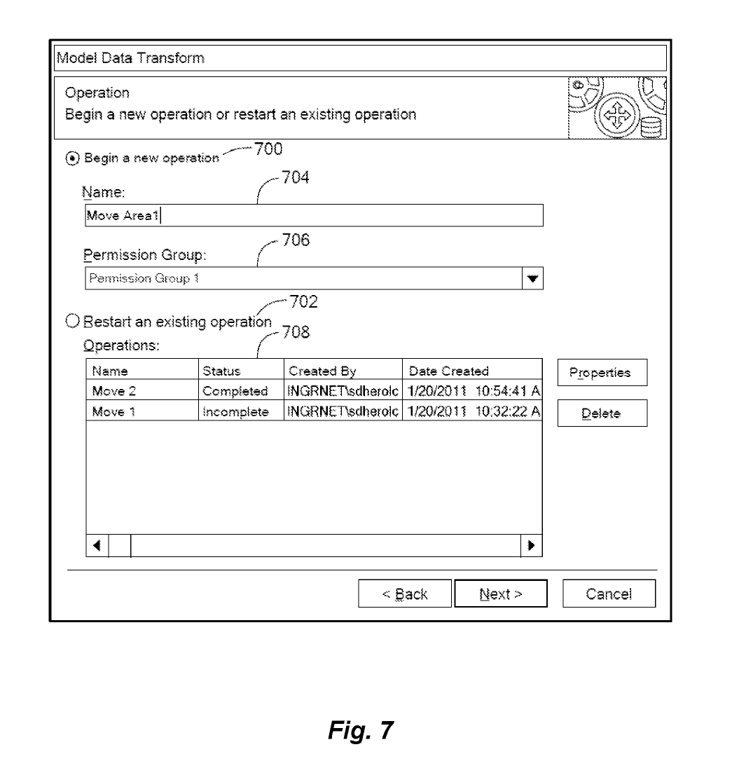

FIG. 7 illustrates a dialog box that accepts user inputs to select between beginning a new transformation operation 700 and continuing or restarting a previously-started (exiting) transformation operation 702. If a new operation 700 is to be begun, the user may name the operation 704 and specify a permission group 706. On the other hand, if an existing operation is to be restarted 702, the user may select a previously-started transformation operation, such as by its name, from a selector box 708.

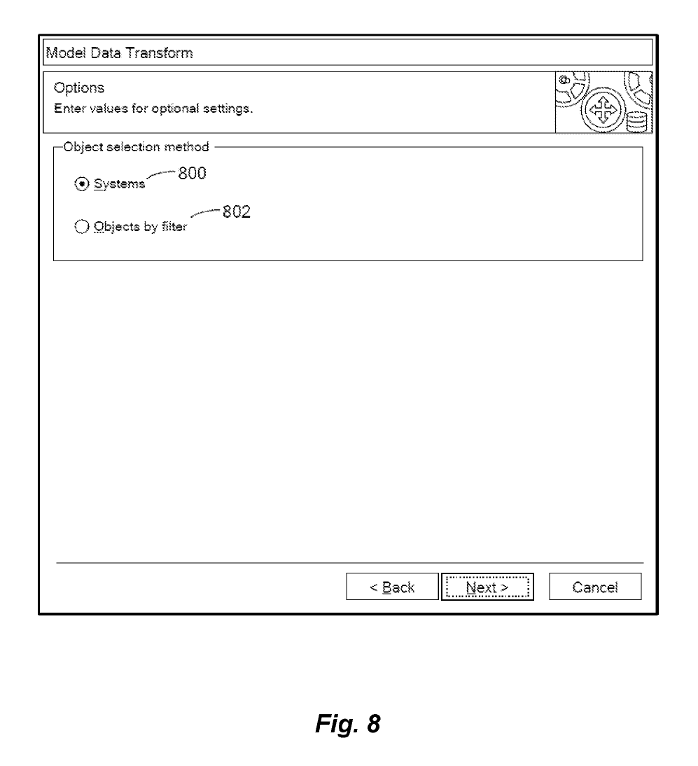

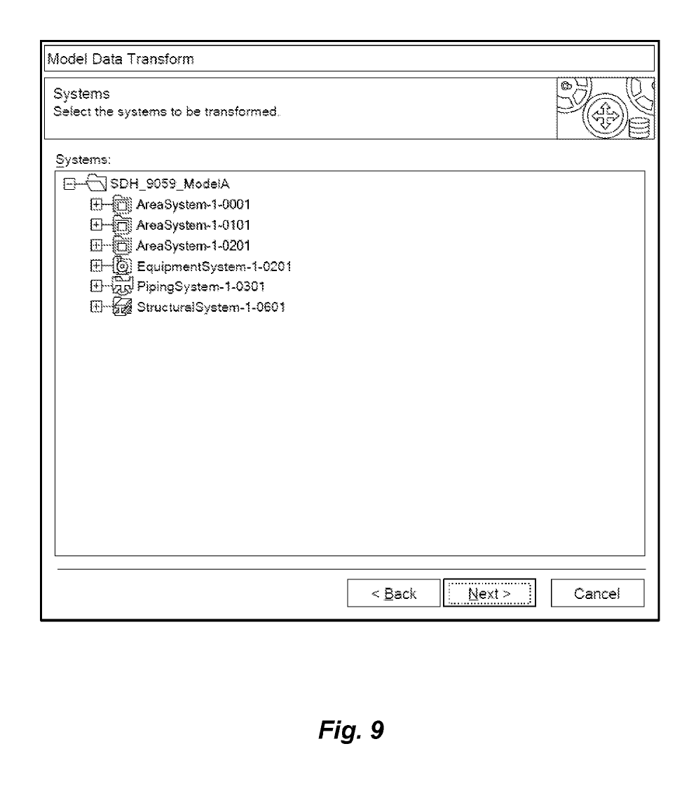

FIG. 8 illustrates a dialog box that allows a user to select objects to be transformed, based on which system they belong to 800 or based on a filter 802. If the objects are to be selected by system, FIG. 9 illustrates a dialog box that allows a user to select the system to be transformed.

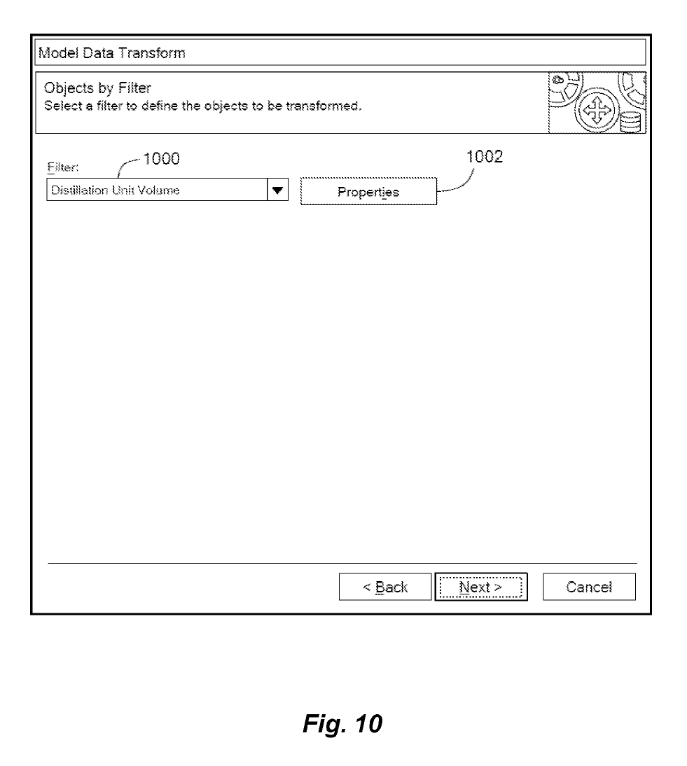

On the other hand, if the objects are to be selected by a filter 802 (FIG. 8), FIG. 10 illustrates a dialog box that allows a user to select a predefined filter 1000 and optionally modify the filter's criteria 1002 or specify criteria for a new filter. Filters may be implemented by queries of the database 316 (FIG. 3). Exemplary filters include: a “volume” filter (which represents a query based on the geometric location of design objects, i.e., objects within a specified three-dimensional volume or a two-dimensional area are selected) and a “property” filter (which represents a query based on one or more values of properties, such as size, weight-bearing capacity, composition or name of design objects). More complex filters may created by combining filters with Boolean operators, such as “AND” and “OR.” Preferably, the query is performed without binding the selected objects into memory. Instead, the query returns a list of object identifiers (OIDs). An OID is a number, string, database key or other quantity that uniquely identifies an object and that may be used to fetch the object from a database into memory (referred to as “binding” the object).

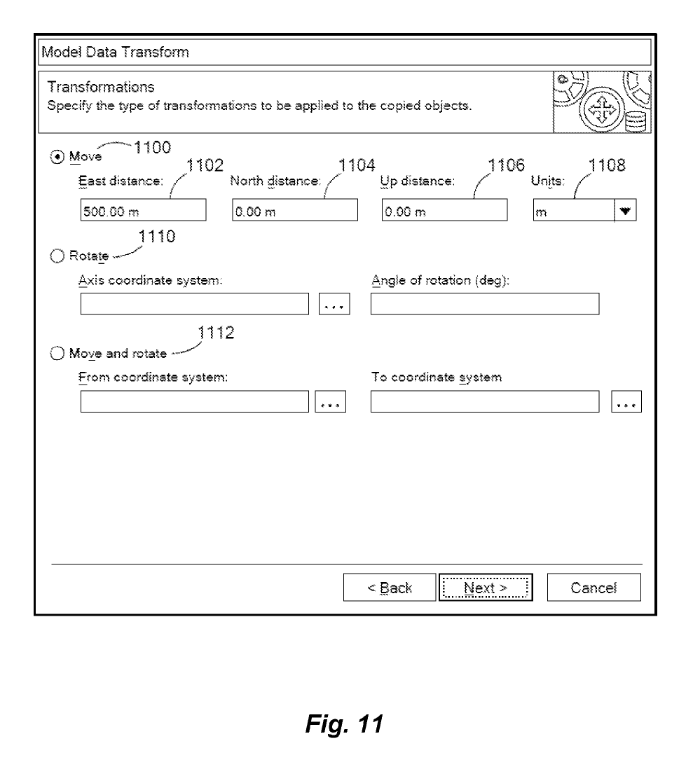

FIG. 11 illustrates a dialog box that accepts user inputs to specify transformations that are to be applied to the selected objects. For example, the objects may be moved 1100 a user-specified number of units in three orthogonal directions 1102, 1104 and 1106. A user may specify the unit of measure in 1108. Other types of transformation may optionally or alternatively be selected. For example, the user may select to rotate 1110 the selected objects or to move and rotate 1112 the selected objects. Other types of transformations, such as mirroring about an axis (not shown), may be presented as options to the user. If the user elects to perform the operation, a transformation operation object is created to keep track of information about the transformation and status of each transaction, into which the transformation will be divided.

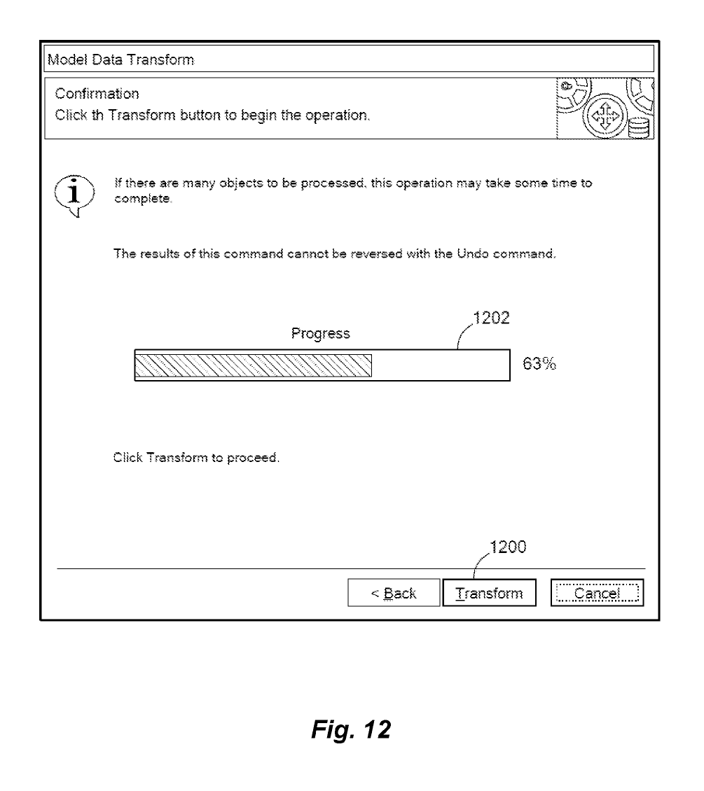

FIG. 12 illustrates a confirmation dialog box. Once the user initiates 1200 the transformation operation, the system may display a progress indicator 1202. After all the partition transformation operations complete successfully, or if the transformation operation is abnormally terminated, a results dialog box may be displayed to the user to report status, as shown in FIG. 13. As noted, a transformation operation may take minutes, hours or longer to complete.

### Transforming the Partitions

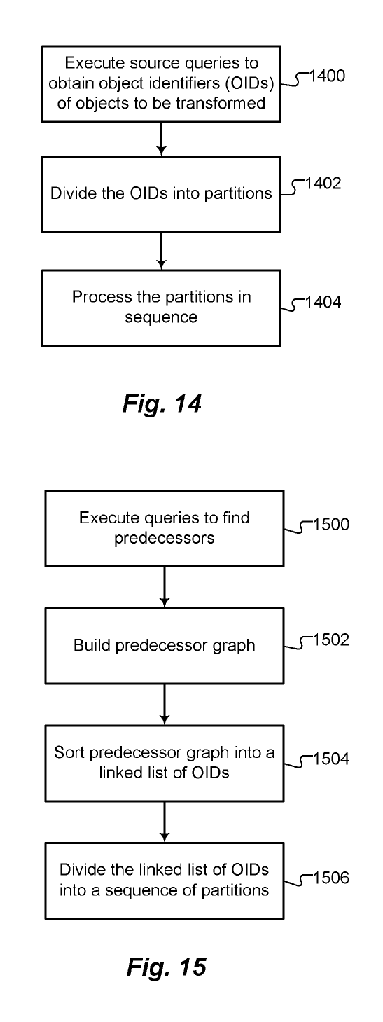

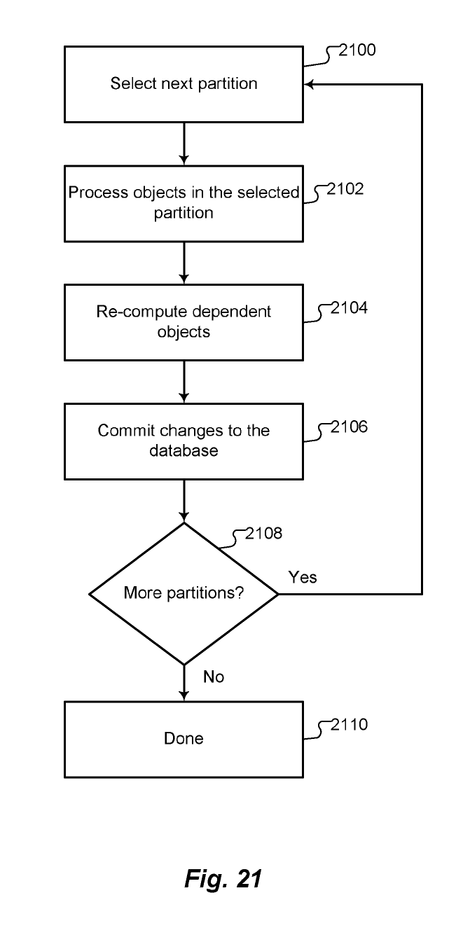

As noted with respect to FIG. 4, once the user input has been collected to specify the design objects to be transformed 400, the transform operations may be performed 402. FIG. 14 is a high-level flowchart illustrating sub-operations of the transformation operation 402 (FIG. 4). At 1400, the database 316 (FIG. 3) is queried to obtain object identifiers (OIDs) of the design objects that are selected by the user for transformation. As noted above, with respect to FIGS. 8-10, the query is performed without binding the selected objects into memory. At 1402, the list of OIDs is divided, according to my rules, into ordered partitions, as described in more detail below, with reference to a flowchart in FIG. 15. At 1404, the ordered partitions are processed in sequence, as described in more detail below, with reference to a flowchart in FIG. 21.

FIG. 15 is a flowchart illustrating operations to divide the list of OIDs into ordered partitions. At 1500, the database 316 (FIG. 3) is queried to identify all predecessor objects for each design object that was selected for transformation. As noted, a predecessor object is a design object, upon which another design object depends. That is, the dependent design object or one or more of its subordinate objects depends on the predecessor design object or one or more of its subordinate objects. At 1502, a predecessor graph is built to organize the identified predecessor objects, and then the predecessor graph is sorted to generate a linked list of OIDs at 1504. The linked list of OIDs is divided at 1506 into a sequence of ordered partitions. A more detailed description of operations 1502-1506 follows.

### Predecessor Graph

In one embodiment, predecessor objects are identified by constructing a directed graph (a “predecessor graph”) that relates each design object that is to be transformed to its predecessors. The predecessor graph includes a node for each design object that is to be transformed. Each node stores an OID for the respective object. Directed edges of the graph represent relationships between respective object nodes. The collection of edges originating at a node identifies all of the predecessor nodes. Similarly, the collection of edges terminating at a node identifies the successor nodes. The objects identified by predecessor nodes should all be transformed before the object identified by the current node.

A traversal of this graph yields an ordered list of objects to be transformed. Sets of consecutive objects from this ordered list are assigned to successive partitions, which are transformed as described herein. All the design objects to be transformed are thus divided into a sequence of partitions. These operations will now be described in detail.

If two design objects are unrelated to each other, the order in which the objects are transformed is irrelevant. However, a relationship between the two design objects may indicate precedence exits between the objects. The relationship may be between one of the design objects or a subordinate object under the design object and the other design object or a subordinate object under the other design object.

As noted, a design object that is selected for transformation often has subordinate objects that should be transformed along with the selected object. For example, a beam object may have several unexposed subordinate connection objects or other subordinate objects. In addition, the beam object may be connected to a predecessor column object, which is exposed to the user. The connection may be made through an unexposed subordinate connection point object related to the column object. As noted, collectively, a design object and its related subordinate objects are referred to as a “design object group” or simply a “group.”

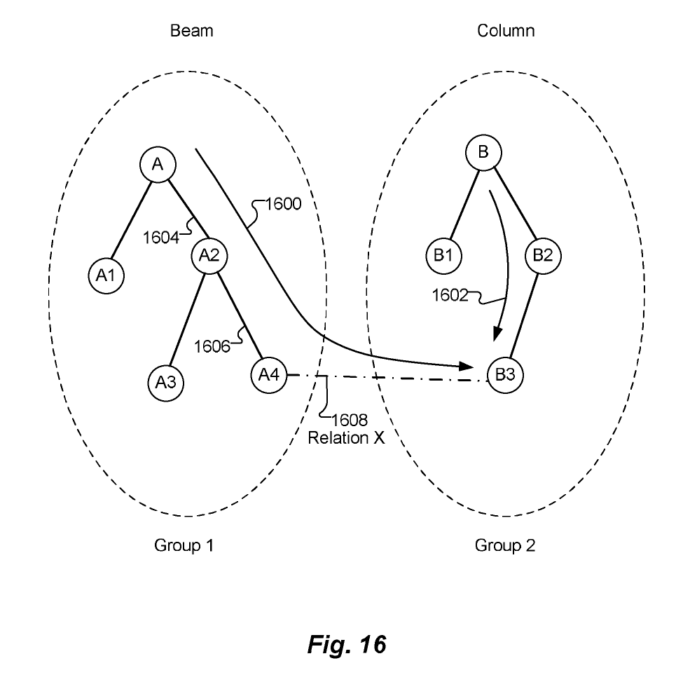

A graphical representation of such a situation is depicted in FIG. 16. Group 1 represents the beam object, and Group 2 represents the column. The design beam object A is related to a number of subordinate and/or exposed objects A1, A2, A3 and A4, all of which should be transformed along with the exposed beam object A. Assume the object A4 represents a connection point on the beam. Similarly, the design column object B is related to a number of subordinate and/or exposed objects B1, B2 and B3. Assume the object B3 represents a connection point on the column, and that a Relationship X represents the connection between the connection points A4 and B3 on the beam and the column, respectively.

The connection object B3 is referred to as a “target” object, because a relationship can be established from another object to the connection object B3. If such a relationship were to be established, the column object B would become a predecessor, and the other design object would become a successor, for purposes of transforming the objects. An object may have more than one target. In addition, relationships other than physical connections may be established. For example, an object may be related to a coordinate system object or to a unit of measurements object. Similarly, an object, such as a beam, may have more than one object through which the object may be related to another object.

As noted, an enterprise engineering system typically includes one or more software tasks 302-306 (FIG. 3) that manage the systems within a plant or a model. These software tasks create objects in response to user inputs, such as when a user adds a beam or a column to a model. In the object-oriented paradigm, a “class” is a definition or prototype of an object. Object-oriented systems have class definitions for each type of object that may be created.

The type of relationship, the objects between which the relationship exists and the meaning, in terms of precedence, are all specific to each software task 302-306. Each task 302-306 supplies information about its design classes in the form of metadata. This metadata allows the core platform 301 to perform queries on the database 316 to find predecessors for each object in the list of objects that are to be transformed.

In accordance with the present invention, each class definition provides information that enables the core platform 301 to traverse two types of paths, relative to the objects: (a) a path from the object, through the internal relationships of its own group, to a target object in another object, with which the object could have a relationship and (b) a path from the object, through the internal relationships of its own group, to a target within its own group, i.e., to a target object through which a relationship may be established to this object. From this information, paths to all targets in predecessor objects may be determined, as well as paths to all possible targets within its own group of subordinate objects. Each path includes a sequence of directed relationships.

The two types of paths are exemplified in FIG. 16. As noted, the beam may be connected to another design object, and the beam's connection object A4 is the object where the connection relationship (Relationship X) would be established. As noted, other of the beam's objects A1-A4 might also be objects through which relationships may be established. Because object A4 can be used to establish a relationship with another object, path 1600 is an example of the first type of path, i.e., a path from the object A, through the internal relationships of its own group of objects, to a target object B3 in another object group, with which the object A could have a relationship (Relationship X). Path 1602 exemplifies the second type of path, i.e., a path from an object B, through the internal relationships of its own group, to a target B3 within the group. The existence of Relationship X indicates that design object B is a predecessor of object A, so object B should be transformed before object A.

In some embodiments, each class definition provides a “class descriptor” file that includes information that a transformation application may use to identify one or both of the two types of paths, depending on whether objects of the class can be targets or the objects can have relationships established to other objects. In some embodiments, this file is formatted according to the extensible markup language (XML) specification. A more detailed description of such an XML file appears below.

As noted, a typical enterprise engineering system stores information about objects and relationships in a relational database (RDB) or in another type of database. Some such systems maintain separate database tables for each type of object. For example, such a system may maintain a table for column objects and a separate table for beam objects. Information about relationships between objects may be maintained in the object tables or in separate tables. For example, a table of relationships, exemplified by Table 1, may record a pair of objects and a relationship between the objects in each row of the table. Thus, for each relationship between two objects in the system, the table contains one row. Table row fields may contain object identifiers (OIDs). The nomenclature “OID (B)” means the “object identifier of object B.” The relationship shown in the second row of Table 1 corresponds to Relationship X shown in FIG. 16, indicating that the connection point A4 on the beam A is an end-to-mid connection to point B3 on column B.

TABLE 1

| Origin | Destination | Relation Type |
|---|---|---|
| OID (X) | OID (Y) | End-to-end connection |
| OID (A4) | OID (B3) | End-to-mid connection |

As indicated by the column headings (“Origin” and “Destination”) in Table 1, relationships are directed. The direction of a relationship may, but need not, imply a successor/predecessor relationship between the two corresponding objects.

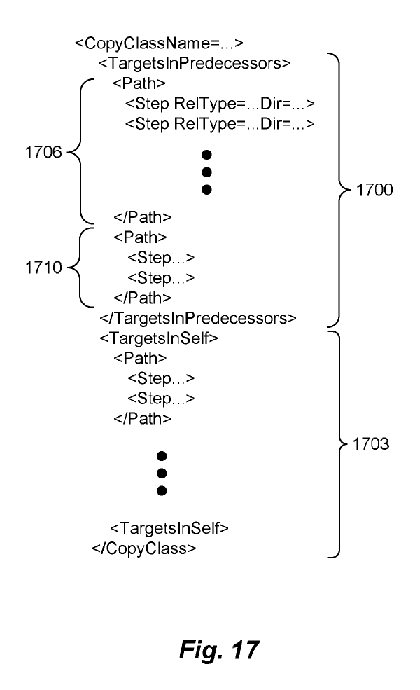

As noted, each class definition provides a class descriptor file containing information that enables software to traverse the two types of paths, relative to the objects instantiated according to the class. FIG. 17 contains an exemplary XML file fragment for providing this information. Other suitable file formats may also be used.

For a given class of objects, the file contains two portions 1700 and 1703 that provide information about the two types of paths, respectively. The first portion 1700 (“TargetsInPredecessors”) provides information about each possible path from the object, through the internal relationships of its own group of subordinate objects, to a target object in another object, with which the object could have a relationship, i.e., to an object that would be a predecessor of the object.

The example shown in FIG. 17 defines two such paths 1706 and 1710. Each path includes at least one “step.” A step describes a relationship between two objects, including a description of the relationship type (RelType) and a direction of the relationship (Dir). Using the beam object of FIG. 16 as an example, the path 1600 would be described as having three steps, corresponding to the relationships 1604, 1606 and 1608. Starting at the object, any path that matches the number of specified step(s), the specified relationship type(s) (RelType) and the specified direction(s) (Dir), qualifies as a TargetsInPredecessors path.

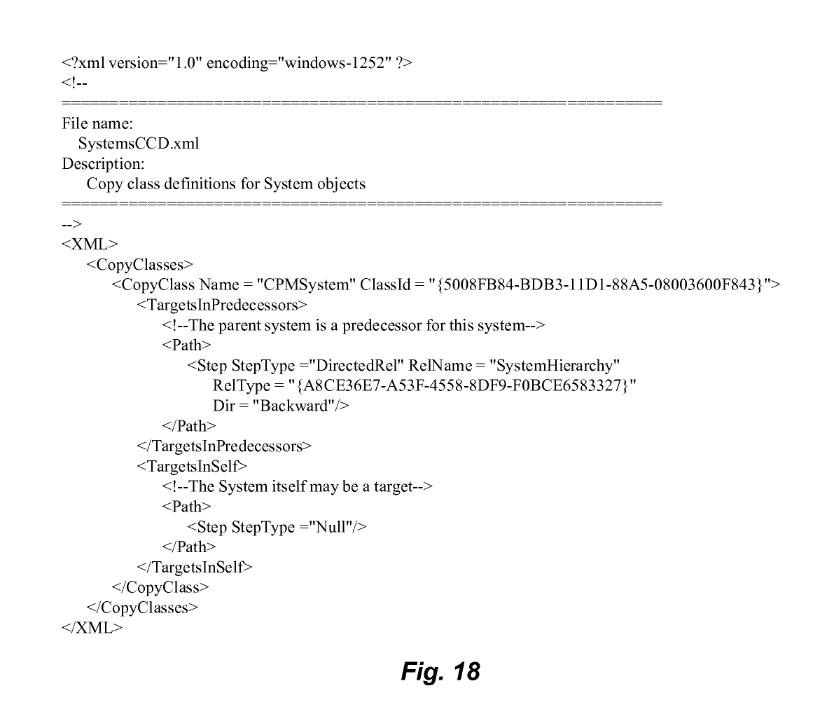

Returning to FIG. 17, the second portion 1703 (“TargetsInSelf”) of the XML file provides information about each possible path from the object, through the internal relationships of its own group, to a target within the group. FIG. 18 is a more complete example of an XML class descriptor file.

When an object is selected by a user or automatically identified by the system as an object to be transformed, the system automatically identifies predecessors of the corresponding design object. To identify the predecessors, the system identifies target objects in the predecessors, to which the selected object, or one of its subordinate objects, is related. To identify the target objects, the system builds a query for each TargetsInPredecessors path defined for the object class. The query starts with the OIDs of all design objects for the given class that are to be transformed and contains a JOIN for each step of the path. The query is executed against the relationship table in the database 316 (FIG. 3). The query results in a table containing OID pairs. Each pair of OIDs includes an OID of an object to be transformed, such as the beam (OID “A”), and an OID of a target object, such as the connection point (OID “B3”). Table 2 illustrates a portion of an exemplary result of such a query.

TABLE 2

| OID of Object to be Transformed | OID of Target Object |
|---|---|
| A | B3 |

The system also builds a query for each TargetsInSelf path defined for the object class. The query starts with the OIDs of all design objects for the given class that are to be transformed and contains a JOIN for each step of the path. The query is executed against the relationship table in the database 316 (FIG. 3). The query produces a table containing pairs of OIDs. Each pair of OIDs includes an OID of an object to be transformed, such as the column (OID “B”), and an OID of a target object, such as the connection point (OID “B3”). Table 3 illustrates a portion of an exemplary result of such a query.

TABLE 3

| OID of Object to be Transformed | OID of Target Object |
|---|---|
| B3 | B |

The above-described queries are executed for each class of object that is selected for transformation, and the results of the queries are accumulated in the two resulting tables. The two tables are then joined on the table column named “OID of Target Object” to produce a third table. Table 4 illustrates a portion of an exemplary result of such a database JOIN operation. The rows of Table 4 represent predecessor relationships among the objects that are to be transformed. For example, according to the first row of Table 4, object B should be transformed no later than object A, because object B is a predecessor of object A.

TABLE 4

| OID of Object to be Transformed | OID of Predecessor Object |
|---|---|
| A | B |

As noted, a predecessor graph includes a node for each design object that is to be transformed, and edges of the graph represent relationships between the respective object nodes. The system creates a node in this graph for each design object selected by the user. In addition, the system adds an edge to this graph for each design object that is identified as a predecessor in the Table 4.

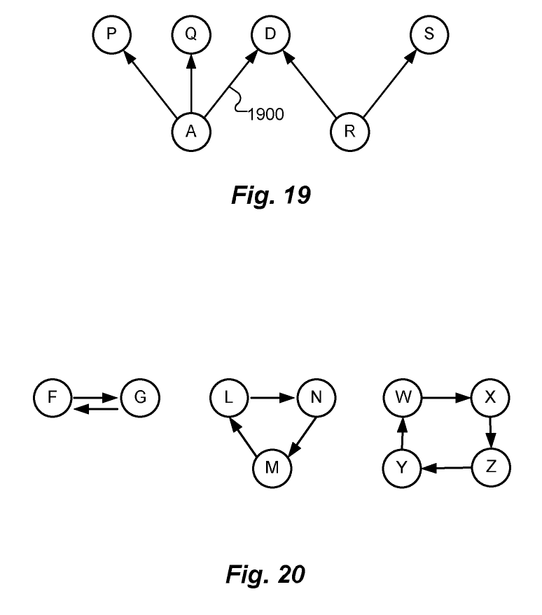

Each row of the joined table (Table 4) represents a predecessor relationship between an object that is to be transformed and a predecessor object. The system adds an edge to the predecessor graph for each such predecessor relationship. FIG. 19 illustrates an exemplary predecessor graph. It should be noted that the predecessor relationship 1900 has been created for the purpose of determining a transformation order. This relationship may exist solely in the predecessor graph. That is, the data structures representing objects in Group 1 and Group 2 (FIG. 16) may not necessarily store information about the predecessor relationship 1900.

### Sorting Objects into Transformation Order

As noted at 1504 (FIG. 15), after the predecessor relationships have been added to the predecessor graph, the objects in the graph are sorted into a transformation order, such that each predecessor object appears no later than all the objects that depend on it. The transformation order may be represented by a linked list (such as forward and backward pointers) extending through the nodes of the predecessor graph, or by a separate ordered list, or by any other suitable indicator.

The predecessor graph may be sorted by any suitable method. Two exemplary methods will now be described. In a breadth-first sorting method, multiple passes may be made through the list of objects that are to be transformed. During each pass, the objects, all of whose predecessor objects have already been added, may be added to the list. This sorting method tends to put unrelated objects near each other in the transformation order list.

It may be desirable to use a depth-first sorting method that puts related objects near each other in the transformation order list. A single pass may be made over the predecessor graph to identify all objects that have no successor objects, i.e., to identify objects that are not predecessors to any other objects. For each object that has no successors, a recursive function may be called to add the object to the list. The function calls itself for each predecessor of the object, and then the function adds the object to the list. Thus, all the object's predecessors are added to the list before the object itself is added to the list.

Two or more objects may be interrelated so as to form loops. Examples of such relationships are shown in FIG. 20. Loops may be detected during the sorting process. If a loop is detected, all the objects of a given loop are assigned to the same partition, so as to be transformed together.

Two objects, each of which considers the other object to be its predecessor, are referred to as “mutual predecessors.” Mutual predecessor objects are assigned to the same partition. Similarly, loops of mutual predecessor objects are assigned to the same partition.

Once the objects in the predecessor graph are sorted, the objects may be assigned to successive partition, starting with the object at the beginning of the sorted predecessor graph and continuing in sort order to the end of the graph.

The number of objects in each partition may depend on whether a loop or mutual predecessor objects are found. Otherwise, the number of objects in a partition may be chosen based on one or more criteria. For example, smaller partitions tend to increase robustness, in that if a partition transformation operation fails, the identity of the object causing the failure is easier to ascertain than if a larger transformation operation fails. However, smaller partition transformation operations imply a larger number of such operations, which may negatively impact database performance. Partitions may include as few as one design object. All the partitions need not contain equal numbers of objects. I found that a partition size of one design object provides a good balance between robustness and performance. However, other group sizes may be used.

Objects may be assigned to partitions starting at the head of the sorted list of objects and continuing until all objects have been assigned to a respective partition.

### Transforming Objects in each Partition

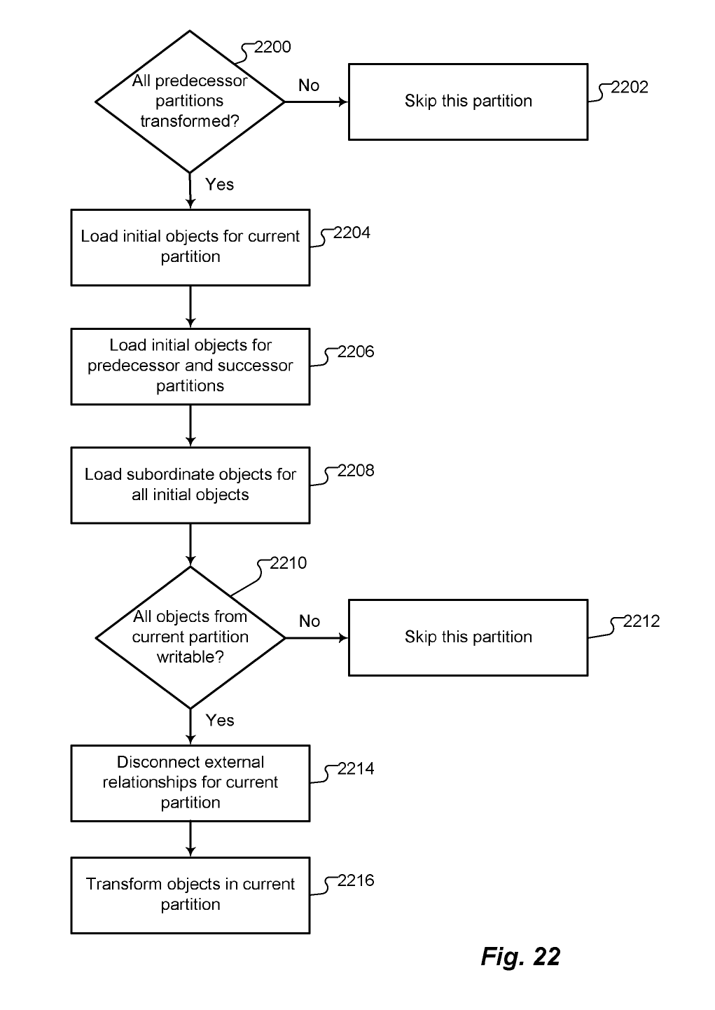

As noted at 1404 (FIG. 14), after the objects have been sorted into a transformation order and divided into ordered partition, the ordered partitions are processed in sequence, as summarized in a flowchart in FIG. 21 and described in more detail below. The flowchart includes a loop. One partition is processed per traversal of the loop. At 2100, the next sequential partition is selected, and the selected partition is processed at 2102. The processing at 2102 is expanded on in FIG. 22 and explained in more detail below. After all the objects in the selected partition have been processed, objects that depend on the processed objects are re-computed at 2104, and changes are committed to the database at 2106. Each traversal of the loop is an atomic operation. That is, either all the operations 2100-2106 are completed or nothing is committed to the database at 2106.

As each partition of objects is transformed, objects in predecessor and successor partitions are placed into a temporary “frozen” (read-only) state, and a “to-do” record is generated for each such frozen object, which effectively defers transforming the frozen object until its respective partition is transformed. When a frozen object is eventually transformed, its corresponding to-do record is deleted. Thus, after all the partitions have been transformed, no to-do records should remain. The to-do records are generated and deleted within operation 2102.

If more partitions remain to be processed, at 2108 control returns to 2100, where the next partition is selected. After all the partitions have been processed, control passes to 2110. After the last partition has been transformed, if any to-do records remain, a failure indicator is set to indicate that at least one frozen object was not transformed. On the other hand, if no to-do records remain, a success indicator is set.

FIG. 22 is a flowchart that describes processing of objects in a single partition (the “current partition”), i.e., the flowchart expands on operation 2102 (FIG. 21). If all partitions that are predecessors of the current partition (“predecessor partitions”) have not yet been transformed, the current partition is skipped at 2202. However, if all predecessor partitions have been transformed, control passes to 2204, where the design objects specified by the user to be transformed (“initial objects”) are loaded into memory (“bound”) from the database 316 (FIG. 3).

At 2206, initial objects from any predecessor partitions and any successor partitions are also bound into memory, and these objects are frozen. Objects in predecessor partitions have already been transformed, i.e., in an earlier transaction. These objects are frozen to prevent doubly transforming them, i.e., once as a result of having been selected for transformation by the user and a second time as a result of being a predecessor object to an object that was selected for transformation.

Objects in predecessor partitions are bound into memory to facilitate identification of external relationships. Objects in successor partitions are bound into memory for two reasons: (1) so they can be frozen to prevent re-computation while the current partition is being transformed and (2) to facilitate identification of external relationships. Any relationship from an object in the current partition to an object in a predecessor or successor partition is not external. However, a relationship from an object in the current partition to an object that is neither in a predecessor nor a successor partition is an external relationship.

As noted, some objects have subordinate objects. If an object that has a subordinate object is selected for transformation, the partition is enlarged to include the subordinate object(s). At 2208, any objects that are subordinate to any of the objects bound at 2204 or 2206 are identified, bound into memory and added to the current partition. More details on enlarging the partition (a process referred to as “propagation”) are provided below.

At 2210, if all the objects in the current partition are not writable, the current partition is skipped at 2212, otherwise control passes to 2214.

As noted, an external relationship may exist between two objects, one of which is selected for transformation and the other of which is not selected for the transformation. For example, if a dependent object is selected for geometric transformation, but the object from which the dependent object depends (i.e., its predecessor object) is not also selected for the transformation, the selected object is involved in an external relationship. Similarly, if an independent object is selected for geometric transformation, but one or more of its dependent objects are not also selected for the transformation, the selected object is involved in an external relationship. Several optional or alternative approaches may be used to handle external relationships.

In the preferred embodiment, the external relationship is broken, i.e., the objects are disconnected from each other. Treatment of the dependent object may depend on domain specific requirements. For example, in some cases, if the dependent object can exist without a relationship to its predecessor object, the dependent object becomes independent. On the other hand, if the dependent object cannot exist without a relationship to its predecessor, the dependent object is deleted. In other cases, the dependent object is handled differently, as required by the domain specific requirements. At 2214, external relationships are disconnected.

In another embodiment, the user may be prompted and given an opportunity to add the predecessor object to the list of objects that are to be transformed. In another embodiment, the predecessor object may be automatically added to the list of objects that are to be transformed, with or without notifying the user. The enterprise engineering system may include a user-selectable or administrator-selectable parameter, by which one of these actions may be selected.

At 2216, the objects in the current partition are transformed. The objects in any given partition may be transformed in any order. After all the objects in the current partition have been successfully transformed, the objects that were frozen are unfrozen. Data structures representing the transformed objects are committed to the database, as noted at 2106 (FIG. 21). If all operations succeed, the status of the partition's object is set to “Transformed.”

### Transform Graph

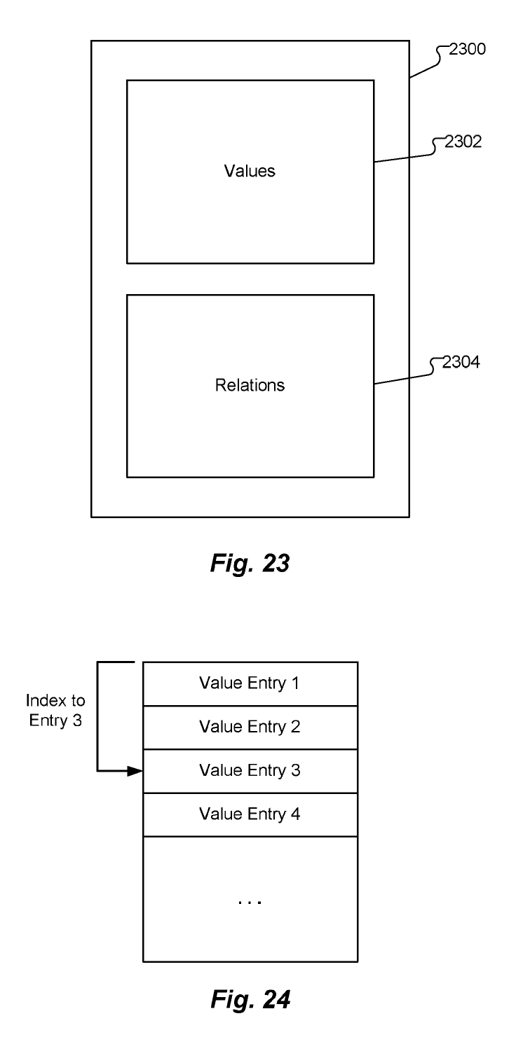

A transform graph data structure is built and used during the processing of each partition, and the data structure may be deallocated after the partition has been processed. The transform graph data structure stores references to objects and relationships among the objects while the partition is transformed. FIG. 23 is a schematic diagram of one embodiment of a transform graph data structure 2300. The transform graph data structure 2300 includes two portions: a values portion 2302 and a relations portion 2304.

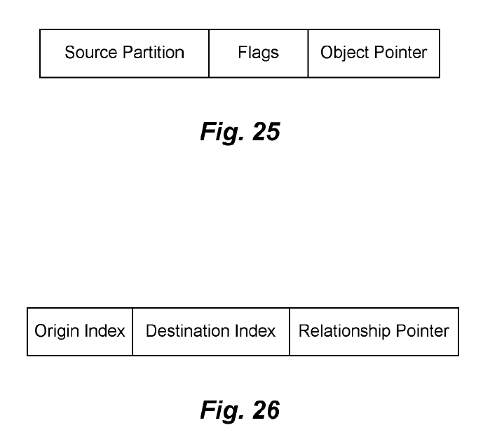

The values portion 2302 includes an array of individual value entries, as shown in FIG. 24. Each value entry represents an object. Each value entry may be uniquely identified by an index into the value array. Each value entry includes several fields, including Source Partition, Flags and Object Pointer, as shown in FIG. 25. The Source Partition identifies a partition to which the corresponding object is associated. Possible values for Source Partition are: Predecessor, Current, Successor and None. The Object Pointer points to the object, once the object has been loaded into memory.

Possible Flags values are listed in Table 5. As noted, a transform graph data structure 2300 is built for each partition. The OIDs of all the objects of the partition are entered into respective entries in the transform graph data structure 2300. These OIDs are used to load the corresponding objects (bind the objects) into memory. For each such object, the Transform flag is set to indicate the object is to be transformed. In addition, for each such object, the Initial flag is set for each initial object.

TABLE 5

Transform
Initial
Predecessor
Successor

The relations portion 2304 (FIG. 23) of the transform graph also includes an array of entries, and each entry can be uniquely identified by an index. Each relationship entry represents a relationship between two objects and includes a Relationship Pointer and two indices (Origin Index and Destination Index) to the two objects that have the relationship represented by the relationship entry, as shown in FIG. 26. The Origin Index contains an index into the values array 2302 to a value entry for an object at the “origin” end of the relationship. The Destination Index contains an index into the values array 2302 to a value entry for an object at the “destination” end of the relationship. The Relationship Pointer contains a pointer to a relationship that has been loaded into memory.

Partitions containing predecessor objects and successor objects of the objects represented by OIDs in the transform graph data structure 2300 are also bound into memory, and OIDs for these objects are added to the transform graph data structure 2300. For each such object, the Initial flag and the Predecessor or Successor flag (as the case may be) are set. The Transform flag is not, however, set, because these objects will not be transformed with the objects in the current partition. The predecessor objects have already been transformed in some previous transaction, i.e., in an earlier partition, and the successor objects will be transformed in some subsequent transaction, i.e., in a later partition. Information is stored in the transform graph data structure 2300 to facilitate freezing these objects and for other purposes.

The objects initially represented in the transform graph data structure 2300 are design objects selected by the user. However, some or all of these design objects may include subordinate objects. Objects that are subordinate to the objects to be transformed in the current partition should also be transformed in the current partition. These objects are bound into memory, and information about these subordinate objects is added to the transform graph data structure 2300 to facilitate: (a) checking whether the subordinate objects are write accessible, (b) identifying external relationships with other objects and disconnecting these external relationships, where necessary and (c) transforming the subordinate objects.

A process called “propagation” adds the subordinate objects to the transform graph data structure 2300. All the relationships of the objects in the transform graph data structure 2300 are explored to identify subordinate objects to be added. Each type ofrelationship includes metadata that defines how the transform graph data structure 2300 should be expanded. Each task 302-306 (FIG. 3) that creates a design object is responsible for relationships that its objects may be involved in and for setting the metadata for these relationships. The core platform 301 (FIG. 3) uses this metadata; thus, the core platform 301 need not be configured with foreknowledge of these relationships or specific information about design objects.

Each relationship entry in the relations portion 2304 of the transform graph 2300 has a type, much like an object has a class. Each relationship type (also referred to as a relationship definition) has a set of properties. These properties are summarized in Table 6.

TABLE 6

| | |
|---|---|
| Expands | If the current object is at the origin of the relationship, |
| Transform | this property controls whether the object at the |
| Forward | destination end of the relationship is added to the |
| | transform graph |
| Expands | If the current object is at the destination of the |
| Transform | relationship, this property controls whether the object |
| Backward | at the origin end of the relationship is added to the |
| | transform graph |

Table 7 summarizes possible values for the properties listed in Table 6.

TABLE 7

| | |
|---|---|
| No Expand | The target object is not involved in the |
| | transform operation |
| Expand to | The target object is a subordinate object |
| Internal Object | of the current design object |
| Expand to | The target object is part of a different |
| External Object | design object |
| Expand to | The target object is a connection object |
| Connection Object | that exists only when two design objects |
| | are connected to each other |

If the Transform flag is set in the Flags, Table 8 governs propagation.

TABLE 8

| Transform Property on | Add Target Object | Set Transform |
|---|---|---|
| Relationship Definition | to the Graph? | flag? |
| No Expand | No | No |
| Expand to Internal Object | Yes | Yes |
| Expand to External Object | Yes | No |
| Expand to Connection Object | Yes | No * |

Connection objects do not belong to any design object. Instead, connection objects exist between design objects for the purpose of connecting them. Connection objects are created for the purpose of connecting two design objects. They are deleted when the two design objects are disconnected. Connection objects are neither internal nor external. The asterisk in Table 8 refers to this special handling of connection objects.

If the Predecessor or Successor flag is set in the Flags, Table 9 governs propagation.

TABLE 9

| Transform Property on | Add Target Object | Set Same Flag as |
|---|---|---|
| Relationship Definition | to the Graph? | Current Object? |
| No Expand | No | No |
| Expand to Internal Object | Yes | Yes |
| Expand to External Object | No | No |
| Expand to Connection Object | Yes | Yes |

When a target object is added to the transform graph data structure 2300, the relationship from the current object to the target object is also added to the transform graph data structure 2300.

Although there may be multiple relationship pathways through the transform graph data structure 2300 to a given object, an object is not added to the transform graph data structure 2300 more than once. It is, however, possible for a second or subsequent pathway to an object to result in the Flags being updated. For example, when an object is first added to the transform graph data structure 2300, the object's flags may not be set. However, during a later phase of propagation, the same object may be found to be a predecessor or successor object. In such a situation, the Predecessor and/or Successor flag is set, as the case may be.

As noted, subordinate objects of the objects in the current partition are bound into memory and access control of the subordinate objects is checked. If any subordinate object is found to be read-only, the partition is marked as containing a read-only object, processing of the partition is ended and a transaction status of Failed Due to Read-Only Object is set for the partition.

A Transformation Propagation Property value of Expand to External Object or Expand to Connection Object indicates that the relationship crosses between design objects and is a candidate for disconnection. If only one of the two design objects of the relationship is selected for transformation, the relationship should be disconnected. As noted, in other embodiments, other types of processing may be provided.

As noted, the Index fields contain indices to the origin object's entry and the destination object's entry in the transform graph data structure 2300. To decide if a relationship should be disconnected, the Flag values at both ends of the relationship are examined. If the Transform flag is set at one end of a relationship, the corresponding object is to be transformed during the current partition's transformation. If neither the Transform, Predecessor nor Successor flag is set at the other end of the relationship, the far-end object has not been transformed and it will not be transformed during the current operation. Such a relationship should be disconnected. These rules are summarized in Table 10.

TABLE 10

| If one object is to | |
|---|---|
| be transformed and | |
| the related object is: | Then: |
| Transformed | Do not disconnect the relationship |
| Predecessor | This object has already been transformed |
| | in a previous transaction and should not |
| | be disconnected |
| Successor | This object will be transformed in a |
| | subsequent transaction and should not |
| | be disconnected |
| Not Transformed, | This object will not be transformed |
| Not Predecessor | during the current operation, and this |
| and Not Successor | relationship should be disconnected |

As noted, object classes are defined by a task 302-306 (FIG. 3). Thus, the task 302-306 defines methods for transforming objects. For each object in the transform graph data structure 2300 that is flagged Transform, the object's transform method is called.

Before computing dependencies, objects in successor partitions, i.e., objects flagged as Successor, are frozen to prevent being recomputed as a result of objects in the current partition being transformed. In subsequent transactions, the objects in successor partitions will be transformed and, as part of that transformation, the objects' values will be recomputed. Each object may implement a method for freezing and unfreezing the object.

After the objects are transformed, functional dependencies are computed. Dependency functions for all modified objects are called. Some of these functions update other (dependent) objects within the current partition. This can be done, because objects in the current partition are writeable. Other dependency functions would otherwise update objects in successor partitions; however, the successor objects have been frozen. Consequently, these objects in the successor partitions become “out of date,” relative to the current partition. A “to do” record is generated for each such out-of-date object. All changes are then committed to the database 316 (FIG. 3)

Typically, the out-of-date objects are transformed in a partition shortly after the current partition is completed. Thus, the to-do records are typically processed and deleted soon after they have been created. However, if a large geometric transformation is interrupted, such as by a user invoking a cancel control or by a hardware or software failure, the to-do records indicate which operations should be performed upon restarting the operation.

As noted, an operation object is created to facilitate restarting the operation. In addition, after the source list of objects has been partitioned, a partition object is created to represent each partition. Relationships are established between the operation object and the partition objects. In addition, relationships are established between each partition object and its predecessor and successor partition's object, respectively. While processing each partition, the corresponding partition object is bound into memory and values of its Transaction Result property are updated, as summarized in Table 11.

TABLE 11

| Transaction | |
|---|---|
| Result Value | Description |
| Not Attempted | Default value for each partition; if the partition |
| | is never updated, this value remains |
| Succeeded | This partition was successfully transformed |
| Predecessors | One or more of the predecessor partitions was not |
| Not Transformed | successfully transformed; therefore, this partition |
| | was not transformed |
| Read-Only Object | This partition contains one or more read-only objects; |
| | therefore, this partition was not transformed |
| Failed | A failure occurred while attempting to transform this |
| | partition; the failure may be caused by a software |
| | defect or a data corruption |

If a failed predecessor partition is found, or if a read-only object is found in the current partition, the corresponding Transaction Result value is set, according to Table 11. On the other hand, if the objects in the current partition are successfully transformed, the Transaction Result value is set to Succeeded. If the modified objects are successfully committed to the database, processing for this partition is considered complete. However, if the commit to the database fails, the Transaction Result value is set to Failed.

If a large geometric transformation fails to complete successfully, the operation and partition objects record the current state of the operation. Typically, before restarting an operation, a user may take some corrective action, such as restarting a failed server or modifying read-only objects to make them writeable. A restart may be initiated the same way as a new geometric transformation may be initiated. The software that starts a new geometric transformation begins by querying the database to ascertain the status of the previous transformation operation, i.e. by querying the operation and partitions objects. Each transformation operation may be named by the invoking user via the Name field 704 (FIG. 7). The user interface for initiating a geometric transformation may display a list of previously started operations, and the user may select a failed operation to restart the operation.

When an operation is restarted, the operation object and all the partition objects of the restarted operation are bound into memory, and processing resumes with the first unprocessed partition. Partitions that have Transaction Result values of Succeeded or Failed are skipped. Other partitions are processed, as described above. A Failed partition indicates a problem with the data, not a problem that a user could control. Problems, such as read-only data, that can be controlled by user are not marked Fail. Because Failed operations cannot be rectified by users, there is little point is allowing a Failed partition to be processed again.

Operation and partition objects may be kept in the database even after the corresponding operation completes successfully to provide a historical record as long as needed, and then the objects may be deleted.

The following hypothetical example illustrates operation of the apparatus and methods described above. The example contains an arbitrarily small number of objects, for simplicity of explanation. However, the principles involved may be applied to larger numbers of objects.

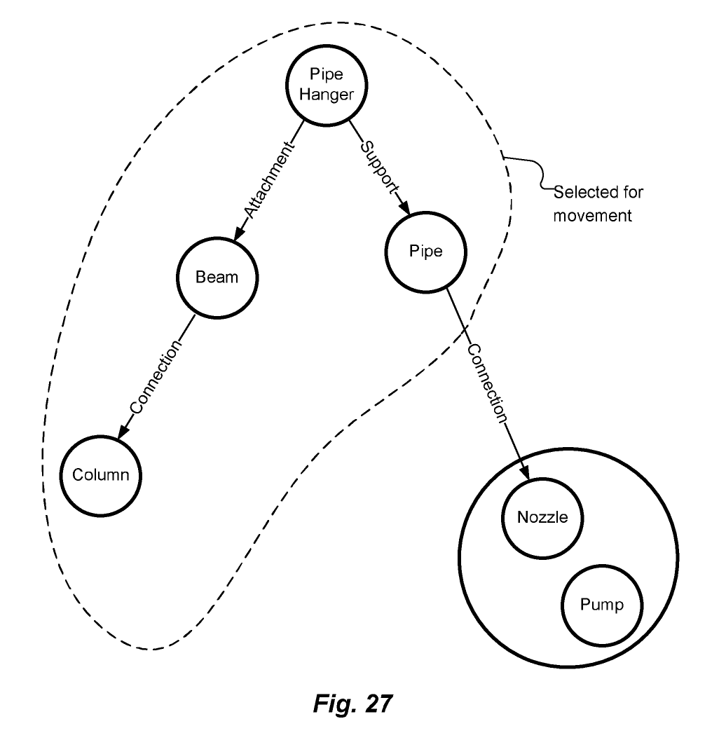

The example involves five interrelated design objects: a Pump, a Pipe, a Column, a Beam and a Pipe Hanger, schematically illustrated in FIG. 27. The Pipe is connected to a Nozzle on the Pump. The Pipe is supported by the Pipe Hanger. The Pipe Hanger is attached to the Beam. The Beam is connected to the Column. Assume a user specified all these objects, except the Pump, are to be moved 100 meters east. Also assume the user has write access to all the objects.

The transformation process includes identifying all predecessors of each design object. The Pump is a predecessor of the Pipe. However, the Pump will not appear in the predecessor graph, because the Pump will not be moved. The Column is a predecessor of the connected Beam. Both the Beam and the Pipe are predecessors of the Pipe Hanger.

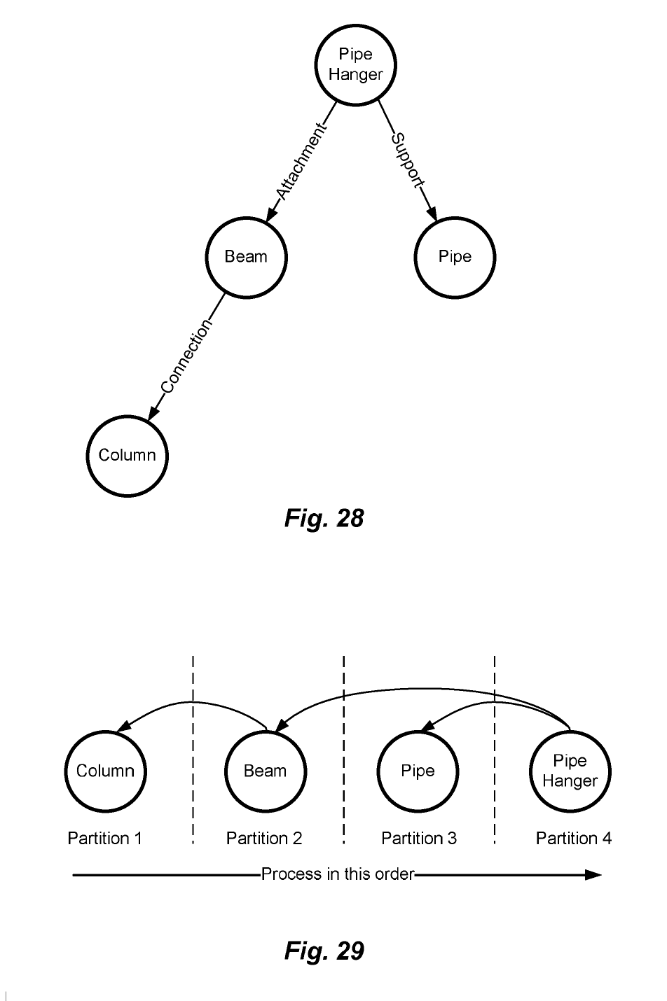

A predecessor graph is constructed from the list of predecessors for each design object (Pipe Hanger, etc.). FIG. 28 is a schematic representation of a predecessor graph that corresponds to the objects in FIG. 27. Arrows point to predecessors for each design object.

The nodes of the predecessor graph are sorted into a linear sequence, such that predecessors appear before successors, as illustrated in FIG. 29. The partitions are then processed in the specified sequence. When processing of each partition is complete, modified objects are committed to the database. Each partition is transformed in a separate atomic transaction. Each transaction will now be described in detail.

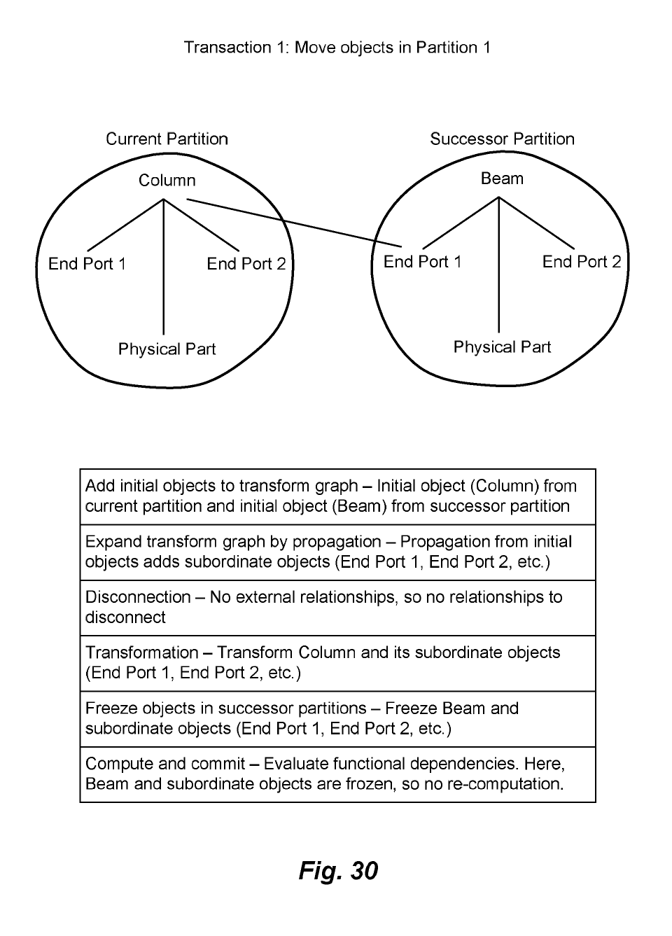

Transaction 1 involves moving the objects of Partition 1, which involves the following operations, summarized and indicated schematically in FIG. 30. Thus, Partition 1 is the current partition during Transaction 1. The initial object (Column) from the current partition and the initial object (Beam) from the successor partition are loaded into memory and added to the transform graph. The transform graph is expanded by propagation. Propagation of the initial objects (Column and Beam) binds subordinate objects (End Port 1, End Port 2 and Physical Part for Column; and End Port 1, End Port 2 and Physical Part for Beam) into memory and into the transform graph. No external relationship is identified. Therefore, no relationship is disconnected. The Column and its subordinate objects (End Port 1, End Port 2 and Physical Part) are transformed (moved 100 meters east). Objects in successor partitions (in this case, there is only one successor partition, i.e., Partition 2) are frozen. Thus, the Beam object and its subordinate objects (End Port 1, End Port 2 and Physical Part) are frozen. Functional dependencies are computed. However, the Beam and its subordinate objects are frozen. Therefore, the Beam and its subordinate objects are not re-computed. The modified (transformed) Column object and its subordinate objects are committed to the database.

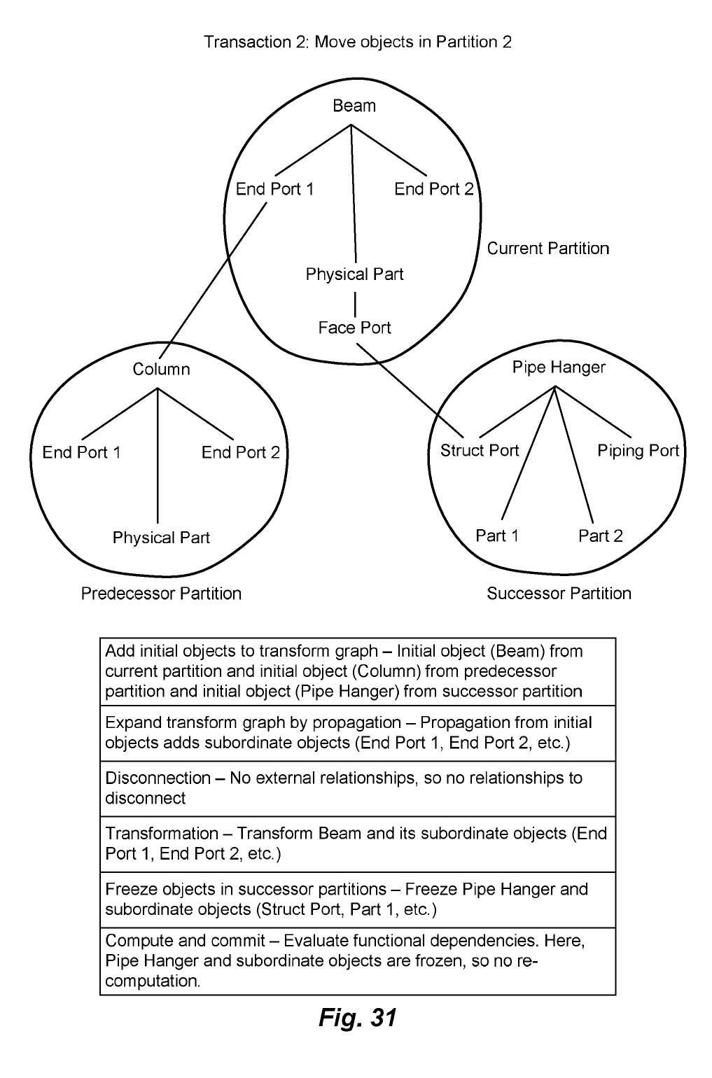

Transaction 2 involves moving the objects of Partition 2, as summarized and indicated schematically in FIG. 31. Partition 2 is the current partition during Transaction 2. The initial object (Beam) from the current partition and the initial object (Column) from the predecessor partition (Partition 1) and the initial object (Pipe Hanger) from the successor partition (Partition 4) are loaded into memory and added to the transform graph. Note that the successor partition is Partition 4, because the Pipe Hanger object depends on an object (Beam) in the current partition. The transform graph is expanded by propagation. Propagation of the initial objects (Beam, Column and Pipe Hanger) binds subordinate objects (End Port 1, End Port 2 and Physical Part for Column; End Port 1, End Port 2, Physical Part and Face Port for Beam; and Struct Port, Part 1, Part 2 and Piping Port for Pipe Hanger) into memory and into the transform graph. No external relationship is identified. Therefore, no relationship is disconnected. The Beam and its subordinate objects (End Port 1, End Port 2, Physical Part and Face Port) are transformed (moved 100 meters east). Objects in successor partitions (in this case, there is only one successor partition, i.e., Partition 4) are frozen. Thus, the Pipe Hanger object and its subordinate objects (Struct Port, Part 1, Part 2 and Piping Port) are frozen. Functional dependencies are computed. However, the Pipe Hanger and its subordinate objects are frozen. Therefore, the Pipe Hanger and its subordinate objects are not re-computed. The modified (transformed) Beam object and its subordinate objects are committed to the database.

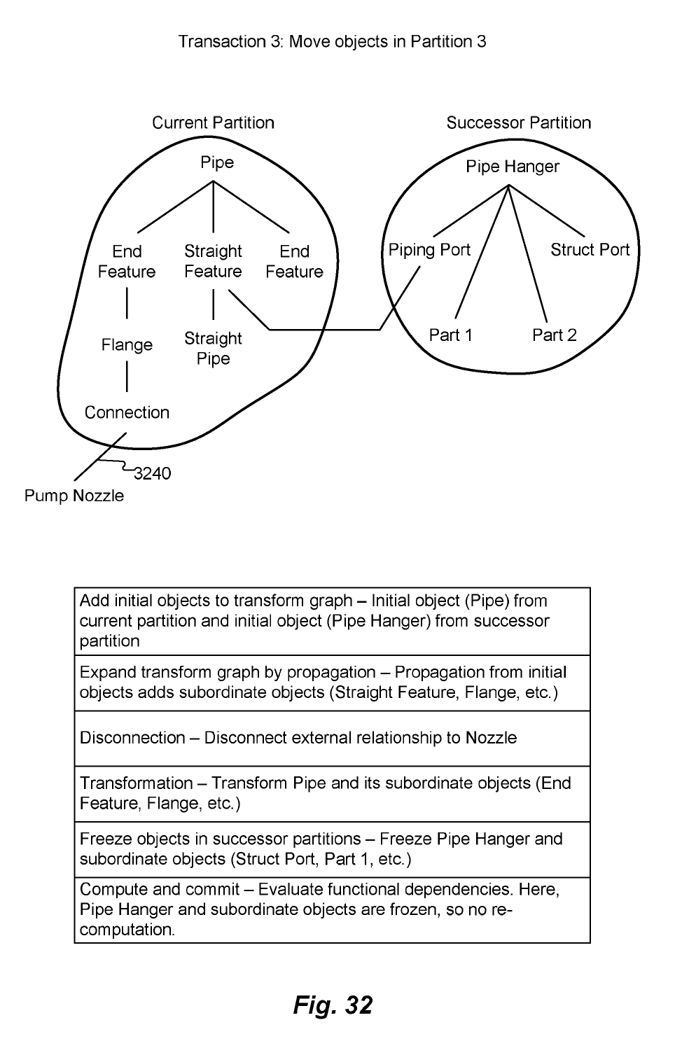

Transaction 3 involves moving the objects of Partition 3, as summarized and indicated schematically in FIG. 32. Partition 3 is the current partition during Transaction 3. The initial object (Pipe) from the current partition and the initial object (Pipe Hanger) from the successor partition (Partition 4) are loaded into memory and added to the transform graph. The current partition has no predecessor partition. The transform graph is expanded by propagation. Propagation of the initial objects (Pipe and Pipe Hanger) binds subordinate objects (End Feature, Flange, Connection, Straight Feature, Straight Pipe and End Feature for Pipe; and Piping Port, Part 1, Part 2 and Struct Port for Pipe Hanger) into memory and into the transform graph. The relationship 3240 between the Pump Nozzle of the Pump and the Connection object of the Pipe is identified as an external relationship and is, therefore, disconnected. The Pipe and its subordinate objects (End Feature, Flange, Connection, Straight Feature, Straight Pipe and End Feature) are transformed (moved 100 meters east). Objects in successor partition (Partition 4) are frozen. Thus, the Pipe Hanger object and its subordinate objects (Struct Port, Part 1, Part 2 and Piping Port) are frozen. Functional dependencies are computed. However, the Pipe Hanger and its subordinate objects are frozen. Therefore, the Pipe Hanger and its subordinate objects are not re-computed. The modified (transformed) Pipe object and its subordinate objects are committed to the database.

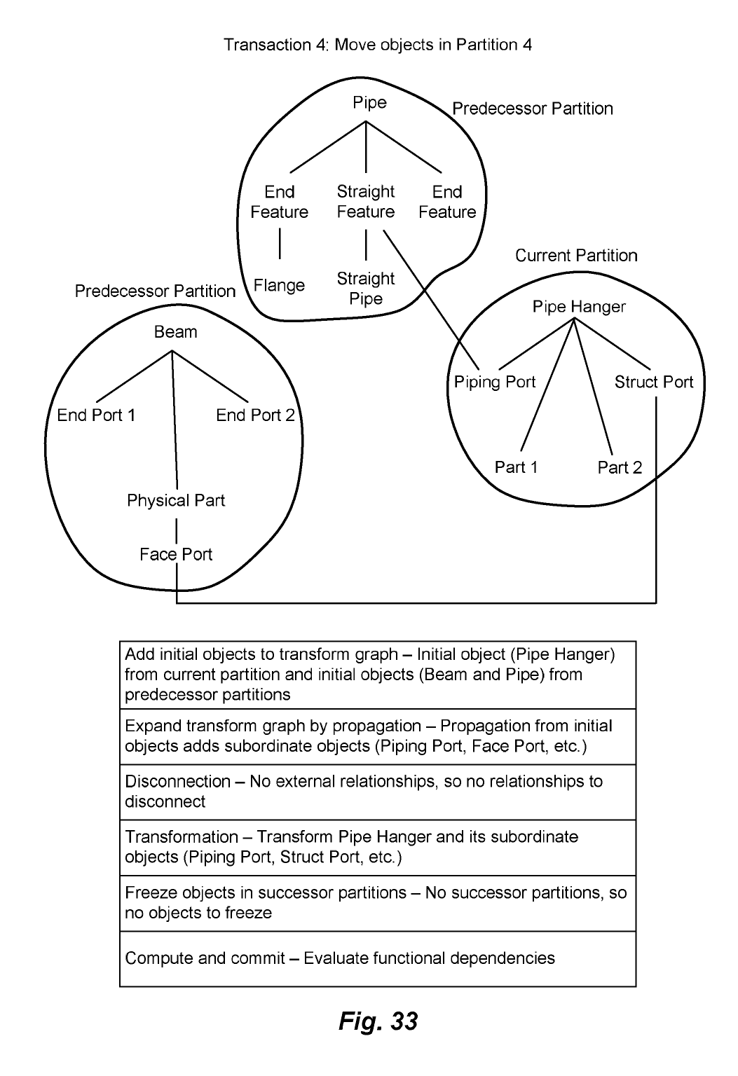

Transaction 4 involves moving the objects of Partition 4, as summarized and indicated schematically in FIG. 33. Partition 4 is the current partition during Transaction 4. The initial object (Pipe Hanger) from the current partition and the initial objects (Beam and Pipe) from the predecessor partitions (Partition 2 and Partition 3) are loaded into memory and added to the transform graph. The current partition has no successor partition. The transform graph is expanded by propagation. Propagation of the initial objects (Pipe Hanger, Beam and Pipe) binds subordinate objects (Piping Port, Struct Port, Part 1, and Part 2 for the Pipe Hanger; End Port 1, End Port 2, Physical Part and Face Port for Beam; and End Feature, Flange, Connection, Straight Feature, Straight Pipe and End Feature for Pipe) into memory and into the transform graph. No external relationship is identified. Therefore, no relationship is disconnected. The Pipe Hanger and its subordinate objects (Struct Port, Part 1, Part 2 and Piping Port) are transformed (moved 100 meters east). There are no successor partitions. Therefore, no objects need to be frozen. Functional dependencies are computed. The modified (transformed) Pipe Hanger object and its subordinate objects are committed to the database.

As a result of the Transactions 1-4, the selected objects have been moved. The Pump object, which was not selected for transformation, has been disconnected from the Pipe.

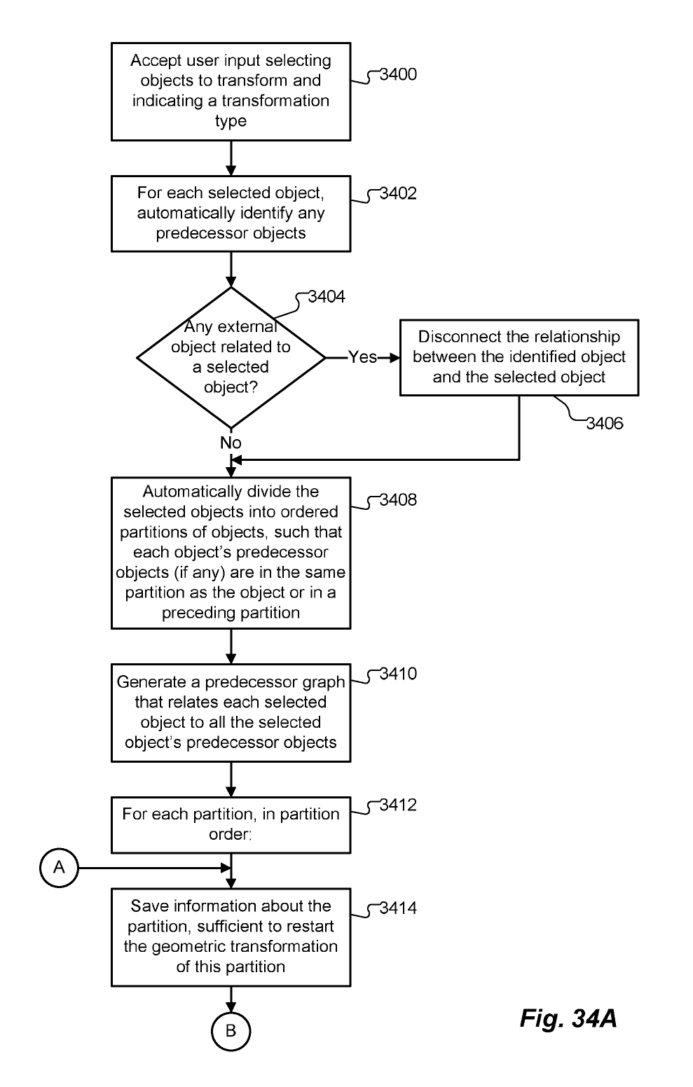

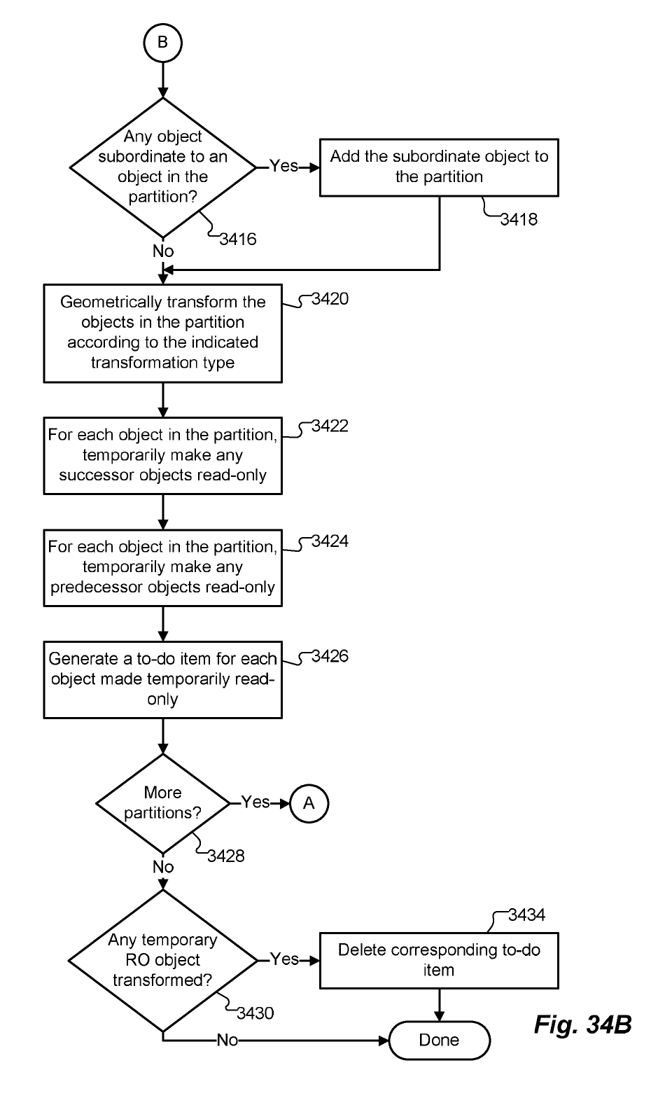

A flowchart in FIGS. 34A-B schematically illustrates a computerized method for geometrically transforming a plurality of objects represented within an object-oriented enterprise engineering system, according to an embodiment of the present invention. At least one of the plurality of objects is a predecessor of another of the plurality of objects. At 3400, user input is accepted to select objects to be transformed and indicate a type of transformation, such as move or rotate. At 3402, for each selected object, any predecessor objects are automatically identified. At 3404, if any external object is related to a selected object, control passes to 3406, where the relationship is disconnected.

At 3408, the selected objects are automatically divided into order partitions of objects, such that each object's predecessor objects (if any) are in the same partition or in a preceding partition. At 3410, a predecessor graph is generated. At 3412, a loop begins executing, the loop being traversed once for each partition, in order. At 3414, information about the partition is saved, sufficient to restart the geometric transformation of the partition. At 3416, a search for subordinate objects is performed. If any object subordinate to an object in the partition is found, control passes to 3418, where the subordinate object is added to the partition. At 3420, the objects in the partition are geometrically transformed, according to the transformation type indicated by the user. For each object in the partition, at 3422, if the object has any successor objects, the successor objects are made read-only. Similarly, at 3424, if any object in the partition has a predecessor object, the predecessor object is made read-only. For each object that was made temporarily, at 3426, a to-do item is generated.

If there are more partitions to process, at 3428 control returns to 3424, otherwise control passes to 3430. At 3430, if any of the objects temporarily made read-only have been transformed, control passes to 3434, where the to-do item corresponding to the object is deleted.

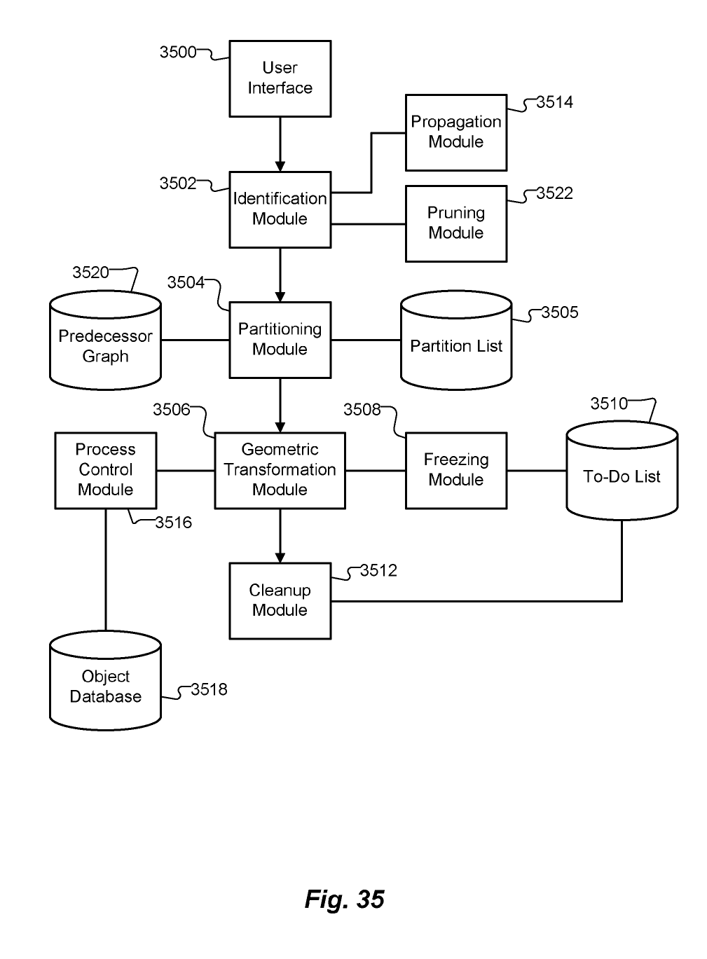

FIG. 35 contains a schematic block diagram of a system for geometrically transforming a plurality of objects represented within an object-oriented enterprise engineering system, according to an embodiment of the present invention. At least one of the plurality of objects is a predecessor of another of the plurality of objects. The system includes a user interface 3500 configured to accept a first input from a user. The input selects a plurality of objects to be geometrically transformed. The user interface 3500 is also configured to accept a second input from the user indicating a type of geometric transformation that is to be performed on the selected objects. An identification module 3502 is coupled to the user interface 3500. The identification module 3502 is configured, for each selected object, to automatically identify any predecessor objects corresponding to the selected object, i.e., where a value of at least one parameter of the selected object is functionally dependent on at least one parameter of the any predecessor objects. A partitioning module 3504 is coupled to the identification module 3502 and is configured to automatically divide the selected objects into a plurality of ordered partitions of objects. For any given object, each of the object's predecessor objects is in the same partition as the given object or in a preceding partition. Partition information may be stored in a partition list 3505 or in any other suitable storage.

A transformation module 3506 is coupled to the partitioning module 3504 and is configured to geometrically transform the objects, according to the indicated type of geometric transformation. The transformation module 3506 transforms the objects per partition, in partition order. A freezing module 3508 is coupled to the transformation module 3506 and is configured to, on a per-partition basis, temporarily make any successor object of each object in the partition read-only and temporarily make any predecessor object of each object in the partition read-only. For each object that was made temporarily read-only, the freezing module 3508 is configured to generate a corresponding to-do item in a to-do list 3510. A cleanup module 3512 is coupled to the transformation module 3506. The cleanup module 3512 is configured to delete corresponding to-do items, if any of the temporarily made read-only objects is subsequently transformed.

A propagation module 3514 is coupled to the identification module 3502. The propagation module 3514 is configured, for each partition, to identify any subordinate objects of the objects in the partition. The identification module 3502 adds the identified subordinate objects to the partition. The transformation module 3506 is configured to geometrically transform the added subordinate objects, according to the indicated type of geometric transformation.

A process control module 3516 is coupled to the transformation module 3506 and is configured to process at least two of the partitions in partition order. The process control module 3516 is configured, for each partition, to save information about the partition. The saved information includes information sufficient to restart geometric transformation the objects in the partition. The information may be saved in an object database 3518 or any other suitable storage. The process control module 3516 also causes the transformation module 3506 to geometrically transform the objects in the partition, according to the indicated type of geometric transformation, before processing a subsequent partition.

The partitioning module 3504 is configured to generate a predecessor graph 3520 that relates each selected object to all the selected object's predecessor objects.

A pruning module 3522 is configured to identify at least one external object that is related to any of the selected objects. The pruning module 3522 disconnects the relationship between the identified external object and the selected object.

Although the object database 3518, the partition list 3505 and the predecessor graph 3520 are shown as separate databases, these elements may be stored in any suitable form, such as tables in a relational database, in-memory data structures, non-relational database files, etc. Furthermore, some or all of these elements may be combined in a single data store, or they may be implemented as fields, pointers, values, etc. in other of the elements.

The above described methods may be performed, and the above described systems may be implemented, by a computer system, including a processor, by executing appropriate instructions stored in a memory. Apparatus for geometrically transforming a large number of objects have been described as including a processor controlled by instructions stored in a memory. The memory may be random access memory (RAM), read-only memory (ROM), flash memory or any other memory, or combination thereof, suitable for storing control software or other instructions and data. Some of the functions performed by the transformation methods and apparatus have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on tangible non-transitory non-writable storage media (e.g. read-only memory devices within a computer, such as ROM, or devices readable by a computer I/O attachment, such as CD-ROM or DVD disks), information alterably stored on tangible non-transitory writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of the illustrated embodiments may be made without departing from the inventive concepts disclosed herein. For example, although some aspects of the transformation mechanism have been described with reference to a flowchart, those skilled in the art should readily appreciate that functions, operations, decisions, etc. of all or a portion of each block, or a combination of blocks, of the flowchart may be combined, separated into separate operations or performed in other orders. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as being limited to the disclosed embodiments.

What is claimed is:

1. A computer-implemented method for geometrically transforming a plurality of objects represented within an object-oriented enterprise engineering system, in which at least one of the plurality of objects is a predecessor of another of the plurality of objects, the method comprising a processor performing operations of:
accepting input from a user selecting the plurality of objects to be geometrically transformed and an indication of a type of geometric transformation that is to be performed on the selected objects;
for each selected object, automatically identifying, among the plurality of objects, any predecessor objects of the selected object, wherein a value of at least one parameter of the selected object is functionally dependent on at least one parameter of the any predecessor objects; and
automatically dividing the selected objects into a plurality of ordered partitions of objects, such that for any given object, each of the object's predecessor objects is in at least one of the same partition as the given object and a preceding partition.

2. A method according to claim 1, further comprising geometrically transforming the objects according to the indication of the type of geometric transformation, per partition of objects, in partition order.

3. A method according to claim 2, further comprising, while geometrically transforming the objects in a given partition:
temporarily making any successor object of each object in the partition read-only; and
temporarily making any predecessor object of each object in the partition read-only.

4. A method according to claim 3, further comprising:
for each object made temporarily read-only, generating a corresponding to-do item; and
if any of the temporarily made read-only objects is subsequently transformed, deleting the corresponding to-do item.

5. A method according to claim 2, further comprising, while geometrically transforming the objects in a given partition:
identifying any subordinate objects of the objects in the partition;
adding the identified subordinate objects to the partition; and
geometrically transforming the added subordinate objects, according to the indication of the type of geometric transformation.

6. A method according to claim 1, further comprising processing at least two of the partitions in partition order, wherein the processing includes:
saving information about the partition; and
geometrically transforming the objects in the partition, according to the indication of the type of geometric transformation, before processing a subsequent partition;
wherein the saved information includes information sufficient to restart geometrically transforming the objects in the partition.

7. A method according to claim 1, wherein automatically dividing the selected objects into a plurality of ordered partitions of objects comprises generating a predecessor graph that relates each selected object to all the selected object's predecessor objects.

8. A method according to claim 1, further comprising:
identifying at least one external object that is related to any of the selected objects; and
disconnecting the relationship between identified external object and the selected object.

9. A system for geometrically transforming a plurality of objects represented within an object-oriented enterprise engineering system, in which at least one of the plurality of objects is a predecessor of another of the plurality of objects, the system comprising:
a user interface configured to accept a first input from a user selecting a plurality of objects to be geometrically transformed and for accepting a second input from the user indicating a type of geometric transformation that is to be performed on the selected objects;
an identification module coupled to the user interface and configured, for each selected object, to automatically identify any predecessor objects corresponding to the selected object, wherein a value of at least one parameter of the selected object is functionally dependent on at least one parameter of the any predecessor objects;
a partitioning module coupled to the identification module and configured to automatically divide the selected objects into a plurality of ordered partitions of objects, such that for any given object, each of the object's predecessor objects is in at least one of the same partition as the given object and in a preceding partition.

10. A system according to claim 9, further comprising a transformation module coupled to the partitioning module and configured to geometrically transform the objects, according to the indicated type of geometric transformation, per partition of objects, in partition order.

11. A system according to claim 10, further comprising a freezing module coupled to the transformation module and configured to, on a per-partition basis:
temporarily make any successor object of each object in the partition read-only; and
temporarily make any predecessor object of each object in the partition read-only.

12. A system according to claim 11, wherein the freezing module is configured to, for each object made temporarily read-only, generate a corresponding to-do item; and further comprising:
a clean-up module coupled to the transformation module and configured to, if any of the temporarily made read-only objects is subsequently transformed, delete the corresponding to-do item.

13. A system according to claim 10, further comprising a propagation module coupled to the identification module and configured to, for each partition:
identify any subordinate objects of the objects in the partition; and
add the identified subordinate objects to the partition; wherein:
the transformation module is configured to geometrically transform the added subordinate objects, according to the indicated type of geometric transformation.

14. A system according to claim 9, further comprising a process control module coupled to the transformation module and configured to process at least two of the partitions in partition order, wherein the process control module is configured to, for each partition:
save information about the partition, wherein the saved information includes information sufficient to restart geometric transformation the objects in the partition; and
cause the transformation module to geometrically transform the objects in the partition, according to the indicated type of geometric transformation, before processing a subsequent partition.

15. A system according to claim 9, wherein the partitioning module is configured to generate a predecessor graph that relates each selected object to all the selected object's predecessor objects.

16. A system according to claim 9, further comprising a pruning module configured to:
identify at least one external object that is related to any of the selected objects; and
disconnect the relationship between the identified external object and the selected object.

17. A computer program product for use on a computer system for copying a plurality of predecessor and successor objects represented within an object-oriented enterprise engineering system, in which each successor object has a predecessor relationship with a predecessor object, the computer program product comprising:
a non-transitory computer-readable medium on which are stored computer instructions such that, when executed by a processor, the instructions cause the processor to:
accept input from a user selecting the plurality of objects to be geometrically transformed and an indication of a type of geometric transformation that is to be performed on the selected objects;
for each selected object, automatically identify, among the plurality of objects, any predecessor objects of the selected object, wherein a value of at least one parameter of the selected object is functionally dependent on at least one parameter of the any predecessor objects; and
automatically divide the selected objects into a plurality of ordered partitions of objects, such that for any given object, each of the object's predecessor objects is in at least one of the same partition as the given object and a preceding partition.

18. A computer program product according to claim 17, wherein the instructions cause the processor to geometrically transform the objects according to the indication of the type of geometric transformation, per partition of objects, in partition order.

19. A computer program product according to claim 18, wherein the instructions cause the processor to:
temporarily make any successor object of each object in the partition read-only; and
temporarily make any predecessor object of each object in the partition read-only.

20. A computer program product according to claim 19, wherein the instructions cause the processor to:
for each object made temporarily read-only, generate a corresponding to-do item; and
if any of the temporarily made read-only objects is subsequently transformed, delete the corresponding to-do item.

21. A computer program product according to claim 18, wherein the instructions cause the processor to, while geometrically transforming the objects in a given partition:
identify any subordinate objects of the objects in the partition;
add the identified subordinate objects to the partition; and
geometrically transform the added subordinate objects, according to the indication of the type of geometric transformation.
